(19) United States
(12) Patent Application Publication
(10) Pub. No.: US 2026/0004611 A1
(43) Pub. Date: Jan. 1, 2026

(54) TECHNIQUES FOR SWITCHING BETWEEN GAZE AND COMPUTER-VISION TARGETING MODALITIES FOR EXTENDED-REALITY (XR) SYSTEMS, AND SYSTEMS AND METHODS OF USE THEREOF

(71) Applicant: Meta Platforms Technologies, LLC, Menlo Park, CA (US)

(72) Inventors: Jaromir Coufal, Seattle, WA (US); Johnathon Simmons, Seattle, WA (US)

(21) Appl. No.: 19/253,661

(22) Filed: Jun. 27, 2025

Related U.S. Application Data
(60) Provisional application No. 63/666,032, filed on Jun. 28, 2024.
(60) Provisional application No. 63/733,951, filed on Dec. 13, 2024.

(51) Int. Cl. G06V 40/18; G06F 3/01; G06T 19/00

(52) U.S. Cl. CPC G06V 40/18; G06F 3/014; G06T 19/006

(57) ABSTRACT

A method for automatic switching between gaze tracking and hand tracking is described. The method occurs while an extended-reality (XR) headset is worn by a user. The method includes obtaining gaze data captured at the XR headset. The method further includes determining, based on the gaze data, a first point of focus within an XR interface presented at a display of the XR headset. The method further includes, in accordance with a determination that the gaze data does not satisfy a gaze-quality threshold: (i) obtaining image data captured at the XR headset indicating a projected-point position of a hand of the user within the XR interface, and (ii) determining, based on the image data and the projected-point position, a second point of focus within the XR interface presented by the display of the XR headset.

### RELATED APPLICATIONS

This application claims priority to U.S. Provisional Application Ser. No. 63/666,032, filed Jun. 28, 2024, entitled “Techniques For Switching Between Gaze And Computer-Vision Targeting Modalities For Augmented-Reality (AR) Systems, Techniques For Switching Selection Modalities, And Systems And Methods Of Using The Techniques” and U.S. Provisional Application Ser. No. 63/733,951, filed Dec. 13, 2024, entitled “Techniques For Switching Between Gaze And Computer-Vision Targeting Modalities For Extended-Reality (XR) Systems, Techniques For Switching Selection Modalities, And Systems And Methods Of Using The Techniques,” which are incorporated herein by reference.

### TECHNICAL FIELD

This relates generally to switching between user input methods of extended-reality (XR) systems.

### BACKGROUND

Extended-Reality (XR) systems include multiple input methods that allow users to interact with XR devices in a variety of ways. All the input methods are not always available to the user, or are not always the best input method, due to limitations such as sensor errors, low quality sensor data, and/or devices disconnecting. Additionally, the user may prefer one input method (e.g., eye-tracking) over another input method (e.g., hand-tracking) and actively choose to use the one input method, even if the accuracy is lesser than the other input method. Typically, the user will need to manually switch the input methods such as through the settings of the XR system, and, thus, there is a desire for input-switching to an available, or most accurate, input method that requires little to no input from the user. Additionally, there is need to indicate such input-switching to the user such that the user is informed that the input method has changed.

As such, there is a need to address one or more of the above-identified challenges. A brief summary of solutions to the issues noted above are described below.

### SUMMARY

A first example of a method for automatic switching between gaze tracking and hand tracking is described herein. A first method occurs while an extended-reality (XR) headset is worn by a user. The first method includes obtaining gaze data captured at the XR headset. The first method further includes determining, based on the gaze data, a first point of focus within an XR interface presented at a display of the XR headset. The first method further includes, in accordance with a determination that the gaze data does not satisfy a gaze-quality threshold: (i) obtaining image data captured at the XR headset indicating a projected-point position of a hand of the user within the XR interface, and (ii) determining, based on the image data and the projected-point position, a second point of focus within the XR interface presented by the display of the XR headset.

A second example of a method for presenting gaze tracking indicators and hand tracking indicators is described herein. A second method occurs while an XR headset is worn by a user. The second method includes, while gaze data is captured at the XR headset: (i) determining, based on the gaze data, a first point of focus within an XR interface presented at a display of the XR headset and (ii) causing the XR headset to present a gaze indicator at the first point of focus. The second method further includes, while image data, indicating a projected-point position of a hand of the user within the XR interface, is captured at the XR headset: (i) determining, based on the image data and the projected-point position, a second point of focus within the XR interface presented by the display of the XR headset and (ii) causing the XR headset to present a hand indicator at the second point of focus.

A third example of a method for automatically switching between biopotential hand gesture tracking and image hand gesture tracking is described herein. A third method includes, while a first focus indicator is over a first selectable XR interface element presented by an XR headset and in response to obtaining biopotential sensor data captured at the wrist-wearable device that indicates performance of a selection gesture, causing performance of a first command associated with the first selectable XR interface element. The third method further includes, in accordance with a determination that the biopotential sensor data does not satisfy a biopotential quality criterion, while a second focus indicator is over a second selectable XR interface element presented by the XR headset, and in response to obtaining image data captured at the XR headset that indicates performance of the selection gesture, causing performance of a second command associated with the second selectable XR interface element.

A fourth example of a method for manual user switching from gaze tracking to hand tracking is described herein. A third method occurs while an XR headset is worn by a user. The fourth method includes obtaining gaze data captured at the XR headset. The fourth method further includes determining, based on the gaze data, a first point of focus within an XR interface presented at a display of the XR headset. The fourth method further includes, in accordance with a determination that the that the user has performed a switch gesture: (i) ceasing obtaining the gaze data captured at the XR headset, (ii) obtaining image data captured at the XR headset indicating a projected-point position of a hand of the user within the XR interface, and (iii) determining, based on the image data and the projected-point position of the hand of the user, a second point of focus within the XR interface presented at the display of the XR headset.

A fifth example of a method for automatic switching between hand tracking and gaze tracking is described herein. A fifth method occurs while an XR headset is worn by a user. The fifth method includes (i) receiving image data from a camera of the XR headset indicating a projected position of a hand of the user within an XR interface presented at a display of the XR headset and (ii) determining, based on the image data and the projected position, a third point of focus within the XR interface presented by the display of the XR headset. The fifth method further includes, in accordance with a determination that the image data does not satisfy an image quality threshold: (i) receiving gaze data from the XR headset and (ii) determining, based on the gaze data, a fourth point of focus within an XR interface presented at a display of the XR headset.

Instructions that cause performance of the methods and operations described herein can be stored on a non-transitory computer readable storage medium. The non-transitory computer-readable storage medium can be included on a single electronic device or spread across multiple electronic devices of a system (computing system). A non-exhaustive of list of electronic devices that can either alone or in combination (e.g., a system) perform the method and operations described herein include an extended-reality (XR) headset/glasses (e.g., a mixed-reality (MR) headset or a pair of augmented-reality (AR) glasses as two examples), a wrist-wearable device, an intermediary processing device, a smart textile-based garment, etc. For instance, the instructions can be stored on a pair of AR glasses or can be stored on a combination of a pair of AR glasses and an associated input device (e.g., a wrist-wearable device) such that instructions for causing detection of input operations can be performed at the input device and instructions for causing changes to a displayed user interface in response to those input operations can be performed at the pair of AR glasses. The devices and systems described herein can be configured to be used in conjunction with methods and operations for providing an XR experience. The methods and operations for providing an XR experience can be stored on a non-transitory computer-readable storage medium.

The features and advantages described in the specification are not necessarily all inclusive and, in particular, certain additional features and advantages will be apparent to one of ordinary skill in the art in view of the drawings, specification, and claims. Moreover, it should be noted that the language used in the specification has been principally selected for readability and instructional purposes.

Having summarized the above example aspects, a brief description of the drawings will now be presented.

### BRIEF DESCRIPTION OF THE DRAWINGS

For a better understanding of the various described embodiments, reference should be made to the Detailed Description below, in conjunction with the following drawings in which like reference numerals refer to corresponding parts throughout the figures.

FIGS. 1A-1I illustrate examples of a user interacting with a user interface (UI) presented by a display of a head-wearable device in response to an automatic change of input methods for controlling the head-wearable device, in accordance with some embodiments.

FIGS. 2A-2D illustrates examples of instructions provided to the user to teach the user how to use hand tracking and/or gaze tracking, in accordance with some embodiments.

FIGS. 3A-3G illustrate a sequence of the head-wearable device and/or the wrist-wearable device automatically switching from biopotential gesture tracking to image gesture tracking to detect hand gestures for interacting with the head-wearable device, in accordance with some embodiments.

FIGS. 4A-4D illustrate the user manually switching the head-wearable device and/or the wrist-wearable device between gaze tracking and hand tracking, in accordance with some embodiments.

FIGS. 5A-5E shows example method flow charts for methods of operating the head-wearable device, in accordance with some embodiments.

FIGS. 6A, 6B, 6C-1, and 6C-2 illustrate example MR and AR systems, in accordance with some embodiments.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DETAILED DESCRIPTION

Numerous details are described herein to provide a thorough understanding of the example embodiments illustrated in the accompanying drawings. However, some embodiments may be practiced without many of the specific details, and the scope of the claims is only limited by those features and aspects specifically recited in the claims. Furthermore, well-known processes, components, and materials have not necessarily been described in exhaustive detail so as to avoid obscuring pertinent aspects of the embodiments described herein.

### Overview

Embodiments of this disclosure can include or be implemented in conjunction with various types of extended-realities (XRs) such as mixed-reality (MR) and augmented-reality (AR) systems. MRs and ARs, as described herein, are any superimposed functionality and/or sensory-detectable presentation provided by MR and AR systems within a user's physical surroundings. Such MRs can include and/or represent virtual realities (VRs) and VRs in which at least some aspects of the surrounding environment are reconstructed within the virtual environment (e.g., displaying virtual reconstructions of physical objects in a physical environment to avoid the user colliding with the physical objects in a surrounding physical environment). In the case of MRs, the surrounding environment that is presented through a display is captured via one or more sensors configured to capture the surrounding environment (e.g., a camera sensor, time-of-flight (ToF) sensor). While a wearer of an MR headset can see the surrounding environment in full detail, they are seeing a reconstruction of the environment reproduced using data from the one or more sensors (i.e., the physical objects are not directly viewed by the user). An MR headset can also forgo displaying reconstructions of objects in the physical environment, thereby providing a user with an entirely VR experience. An AR system, on the other hand, provides an experience in which information is provided, e.g., through the use of a waveguide, in conjunction with the direct viewing of at least some of the surrounding environment through a transparent or semi-transparent waveguide(s) and/or lens(es) of the AR glasses. Throughout this application, the term “extended reality (XR)” is used as a catchall term to cover both ARs and MRs. In addition, this application also uses, at times, a head-wearable device or headset device as a catchall term that covers XR headsets such as AR glasses and MR headsets.

As alluded to above, an MR environment, as described herein, can include, but is not limited to, non-immersive, semi-immersive, and fully immersive VR environments. As also alluded to above, AR environments can include marker-based AR environments, markerless AR environments, location-based AR environments, and projection-based AR environments. The above descriptions are not exhaustive and any other environment that allows for intentional environmental lighting to pass through to the user would fall within the scope of an AR, and any other environment that does not allow for intentional environmental lighting to pass through to the user would fall within the scope of an MR.

The AR and MR content can include video, audio, haptic events, sensory events, or some combination thereof, any of which can be presented in a single channel or in multiple channels (such as stereo video that produces a three-dimensional effect to a viewer). Additionally, AR and MR can also be associated with applications, products, accessories, services, or some combination thereof, which are used, for example, to create content in an AR or MR environment and/or are otherwise used in (e.g., to perform activities in) AR and MR environments.

Interacting with these AR and MR environments described herein can occur using multiple different modalities and the resulting outputs can also occur across multiple different modalities. In one example AR or MR system, a user can perform a swiping in-air hand gesture to cause a song to be skipped by a song-providing application programming interface (API) providing playback at, for example, a home speaker.

A hand gesture, as described herein, can include an in-air gesture, a surface-contact gesture, and or other gestures that can be detected and determined based on movements of a single hand (e.g., a one-handed gesture performed with a user's hand that is detected by one or more sensors of a wearable device (e.g., electromyography (EMG) and/or inertial measurement units (IMUs) of a wrist-wearable device, and/or one or more sensors included in a smart textile wearable device) and/or detected via image data captured by an imaging device of a wearable device (e.g., a camera of a head-wearable device, an external tracking camera setup in the surrounding environment)). “In-air” generally includes gestures in which the user's hand does not contact a surface, object, or portion of an electronic device (e.g., a head-wearable device or other communicatively coupled device, such as the wrist-wearable device), in other words the gesture is performed in open air in 3D space and without contacting a surface, an object, or an electronic device. Surface-contact gestures (contacts at a surface, object, body part of the user, or electronic device) more generally are also contemplated in which a contact (or an intention to contact) is detected at a surface (e.g., a single- or double-finger tap on a table, on a user's hand or another finger, on the user's leg, a couch, a steering wheel). The different hand gestures disclosed herein can be detected using image data and/or sensor data (e.g., neuromuscular signals sensed by one or more biopotential sensors (e.g., EMG sensors) or other types of data from other sensors, such as proximity sensors, ToF sensors, sensors of an IMU, capacitive sensors, strain sensors) detected by a wearable device worn by the user and/or other electronic devices in the user's possession (e.g., smartphones, laptops, imaging devices, intermediary devices, and/or other devices described herein).

A gaze gesture, as described herein, can include an eye movement and/or a head movement indicative of a location of a gaze of the user, an implied location of the gaze of the user, and/or an approximated location of the gaze of the user, in the surrounding environment, the virtual environment, and/or the displayed user interface. The gaze gesture can be detected and determined based on (i) eye movements captured by one or more eye-tracking cameras (e.g., one or more cameras positioned to capture image data of one or both eyes of the user) and/or (ii) a combination of a head orientation of the user (e.g., based on head and/or body movements) and image data from a point-of-view camera (e.g., a forward-facing camera of the head-wearable device). The head orientation is determined based on IMU data captured by an IMU sensor of the head-wearable device. In some embodiments, the IMU data indicates a pitch angle (e.g., the user nodding their head up-and-down) and a yaw angle (e.g., the user shaking their head side-to-side). The head-orientation can then be mapped onto the image data captured from the point-of-view camera to determine the gaze gesture. For example, a quadrant of the image data that the user is looking at can be determined based on whether the pitch angle and the yaw angle are negative or positive (e.g., a positive pitch angle and a positive yaw angle indicate that the gaze gesture is directed toward a top-left quadrant of the image data, a negative pitch angle and a negative yaw angle indicate that the gaze gesture is directed toward a bottom-right quadrant of the image data, etc.). In some embodiments, the IMU data and the image data used to determine the gaze are captured at a same time, and/or the IMU data and the image data used to determine the gaze are captured at offset times (e.g., the IMU data is captured at a predetermined time (e.g., 0.01 seconds to 0.5 seconds) after the image data is captured). In some embodiments, the head-wearable device includes a hardware clock to synchronize the capture of the IMU data and the image data. In some embodiments, object segmentation and/or image detection methods are applied to the quadrant of the image data that the user is looking at.

The input modalities as alluded to above can be varied and are dependent on a user's experience. For example, in an interaction in which a wrist-wearable device is used, a user can provide inputs using in-air or surface-contact gestures that are detected using neuromuscular signal sensors of the wrist-wearable device. In the event that a wrist-wearable device is not used, alternative and entirely interchangeable input modalities can be used instead, such as camera(s) located on the headset/glasses or elsewhere to detect in-air or surface-contact gestures or inputs at an intermediary processing device (e.g., through physical input components (e.g., buttons and trackpads)). These different input modalities can be interchanged based on both desired user experiences, portability, and/or a feature set of the product (e.g., a low-cost product may not include hand-tracking cameras).

While the inputs are varied, the resulting outputs stemming from the inputs are also varied. For example, an in-air gesture input detected by a camera of a head-wearable device can cause an output to occur at a head-wearable device or control another electronic device different from the head-wearable device. In another example, an input detected using data from a neuromuscular signal sensor can also cause an output to occur at a head-wearable device or control another electronic device different from the head-wearable device. While only a couple examples are described above, one skilled in the art would understand that different input modalities are interchangeable along with different output modalities in response to the inputs.

Specific operations described above may occur as a result of specific hardware. The devices described are not limiting and features on these devices can be removed or additional features can be added to these devices. The different devices can include one or more analogous hardware components. For brevity, analogous devices and components are described herein. Any differences in the devices and components are described below in their respective sections.

As described herein, a processor (e.g., a central processing unit (CPU) or microcontroller unit (MCU)), is an electronic component that is responsible for executing instructions and controlling the operation of an electronic device (e.g., a wrist-wearable device, a head-wearable device, a handheld intermediary processing device (HIPD), a smart textile-based garment, or other computer system). There are various types of processors that may be used interchangeably or specifically required by embodiments described herein. For example, a processor may be (i) a general processor designed to perform a wide range of tasks, such as running software applications, managing operating systems, and performing arithmetic and logical operations; (ii) a microcontroller designed for specific tasks such as controlling electronic devices, sensors, and motors; (iii) a graphics processing unit (GPU) designed to accelerate the creation and rendering of images, videos, and animations (e.g., VR animations, such as three-dimensional modeling); (iv) a field-programmable gate array (FPGA) that can be programmed and reconfigured after manufacturing and/or customized to perform specific tasks, such as signal processing, cryptography, and machine learning; or (v) a digital signal processor (DSP) designed to perform mathematical operations on signals such as audio, video, and radio waves. One of skill in the art will understand that one or more processors of one or more electronic devices may be used in various embodiments described herein.

As described herein, controllers are electronic components that manage and coordinate the operation of other components within an electronic device (e.g., controlling inputs, processing data, and/or generating outputs). Examples of controllers can include (i) microcontrollers, including small, low-power controllers that are commonly used in embedded systems and Internet of Things (IoT) devices; (ii) programmable logic controllers (PLCs) that may be configured to be used in industrial automation systems to control and monitor manufacturing processes; (iii) system-on-a-chip (SoC) controllers that integrate multiple components such as processors, memory, I/O interfaces, and other peripherals into a single chip; and/or (iv) DSPs. As described herein, a graphics module is a component or software module that is designed to handle graphical operations and/or processes and can include a hardware module and/or a software module.

As described herein, memory refers to electronic components in a computer or electronic device that store data and instructions for the processor to access and manipulate. The devices described herein can include volatile and non-volatile memory. Examples of memory can include (i) random access memory (RAM), such as DRAM, SRAM, DDR RAM or other random access solid state memory devices, configured to store data and instructions temporarily; (ii) read-only memory (ROM) configured to store data and instructions permanently (e.g., one or more portions of system firmware and/or boot loaders); (iii) flash memory, magnetic disk storage devices, optical disk storage devices, other non-volatile solid state storage devices, which can be configured to store data in electronic devices (e.g., universal serial bus (USB) drives, memory cards, and/or solid-state drives (SSDs)); and (iv) cache memory configured to temporarily store frequently accessed data and instructions. Memory, as described herein, can include structured data (e.g., SQL databases, MongoDB databases, GraphQL data, or JSON data). Other examples of memory can include (i) profile data, including user account data, user settings, and/or other user data stored by the user; (ii) sensor data detected and/or otherwise obtained by one or more sensors; (iii) media content data including stored image data, audio data, documents, and the like; (iv) application data, which can include data collected and/or otherwise obtained and stored during use of an application; and/or (v) any other types of data described herein.

As described herein, a power system of an electronic device is configured to convert incoming electrical power into a form that can be used to operate the device. A power system can include various components, including (i) a power source, which can be an alternating current (AC) adapter or a direct current (DC) adapter power supply; (ii) a charger input that can be configured to use a wired and/or wireless connection (which may be part of a peripheral interface, such as a USB, micro-USB interface, near-field magnetic coupling, magnetic inductive and magnetic resonance charging, and/or radio frequency (RF) charging); (iii) a power-management integrated circuit, configured to distribute power to various components of the device and ensure that the device operates within safe limits (e.g., regulating voltage, controlling current flow, and/or managing heat dissipation); and/or (iv) a battery configured to store power to provide usable power to components of one or more electronic devices.

As described herein, peripheral interfaces are electronic components (e.g., of electronic devices) that allow electronic devices to communicate with other devices or peripherals and can provide a means for input and output of data and signals. Examples of peripheral interfaces can include (i) USB and/or micro-USB interfaces configured for connecting devices to an electronic device; (ii) Bluetooth interfaces configured to allow devices to communicate with each other, including Bluetooth low energy (BLE); (iii) near-field communication (NFC) interfaces configured to be short-range wireless interfaces for operations such as access control; (iv) pogo pins, which may be small, spring-loaded pins configured to provide a charging interface; (v) wireless charging interfaces; (vi) global-positioning system (GPS) interfaces; (vii) Wi-Fi interfaces for providing a connection between a device and a wireless network; and (viii) sensor interfaces.

As described herein, sensors are electronic components (e.g., in and/or otherwise in electronic communication with electronic devices, such as wearable devices) configured to detect physical and environmental changes and generate electrical signals. Examples of sensors can include (i) imaging sensors for collecting imaging data (e.g., including one or more cameras disposed on a respective electronic device, such as a simultaneous localization and mapping (SLAM) camera); (ii) biopotential-signal sensors; (iii) IMUs for detecting, for example, angular rate, force, magnetic field, and/or changes in acceleration; (iv) heart rate sensors for measuring a user's heart rate; (v) peripheral oxygen saturation (SpO₂) sensors for measuring blood oxygen saturation and/or other biometric data of a user; (vi) capacitive sensors for detecting changes in potential at a portion of a user's body (e.g., a sensor-skin interface) and/or the proximity of other devices or objects; (vii) sensors for detecting some inputs (e.g., capacitive and force sensors); and (viii) light sensors (e.g., ToF sensors, infrared light sensors, or visible light sensors), and/or sensors for sensing data from the user or the user's environment. As described herein biopotential-signal-sensing components are devices used to measure electrical activity within the body (e.g., biopotential-signal sensors). Some types of biopotential-signal sensors include (i) electroencephalography (EEG) sensors configured to measure electrical activity in the brain to diagnose neurological disorders; (ii) electrocardiography EKG) sensors configured to measure electrical activity of the heart to diagnose heart problems; (iii) EMG sensors configured to measure the electrical activity of muscles and diagnose neuromuscular disorders; (iv) electrooculography (EOG) sensors configured to measure the electrical activity of eye muscles to detect eye movement and diagnose eye disorders.

As described herein, an application stored in memory of an electronic device (e.g., software) includes instructions stored in the memory. Examples of such applications include (i) games; (ii) word processors; (iii) messaging applications; (iv) media-streaming applications; (v) financial applications; (vi) calendars; (vii) clocks; (viii) web browsers; (ix) social media applications; (x) camera applications; (xi) web-based applications; (xii) health applications; (xiii) AR and MR applications; and/or (xiv) any other applications that can be stored in memory. The applications can operate in conjunction with data and/or one or more components of a device or communicatively coupled devices to perform one or more operations and/or functions.

As described herein, communication interface modules can include hardware and/or software capable of data communications using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi), custom or standard wired protocols (e.g., Ethernet or HomePlug), and/or any other suitable communication protocol, including communication protocols not yet developed as of the filing date of this document. A communication interface is a mechanism that enables different systems or devices to exchange information and data with each other, including hardware, software, or a combination of both hardware and software. For example, a communication interface can refer to a physical connector and/or port on a device that enables communication with other devices (e.g., USB, Ethernet, HDMI, or Bluetooth). A communication interface can refer to a software layer that enables different software programs to communicate with each other (e.g., APIs and protocols such as HTTP and TCP/IP).

As described herein, a graphics module is a component or software module that is designed to handle graphical operations and/or processes and can include a hardware module and/or a software module.

As described herein, non-transitory computer-readable storage media are physical devices or storage medium that can be used to store electronic data in a non-transitory form (e.g., such that the data is stored permanently until it is intentionally deleted and/or modified).

### Switching Between Gaze and Computer-Vision Targeting Modalities for Extended-Reality (XR) Systems

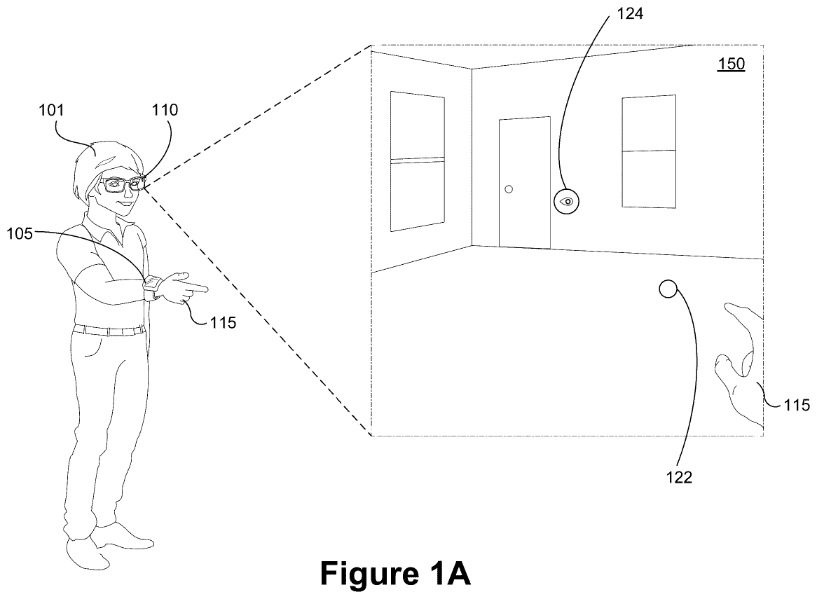

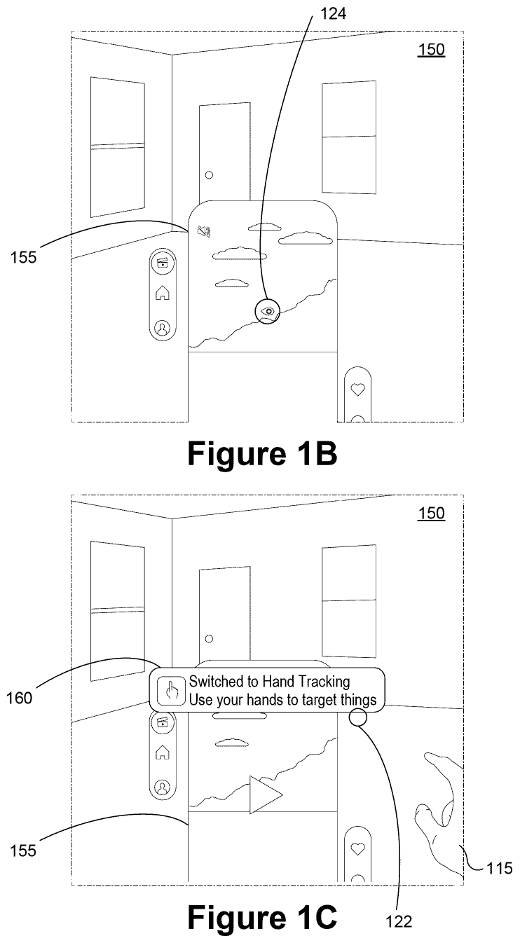

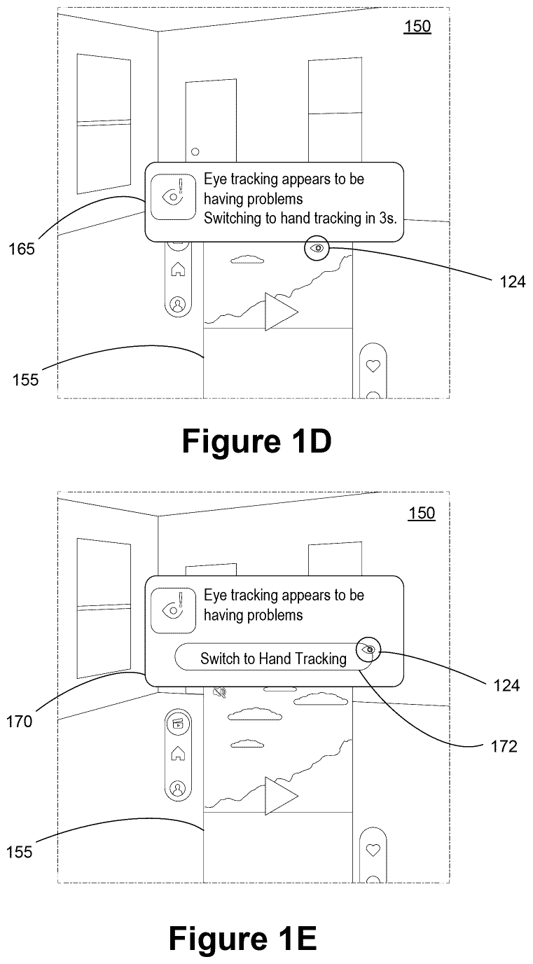

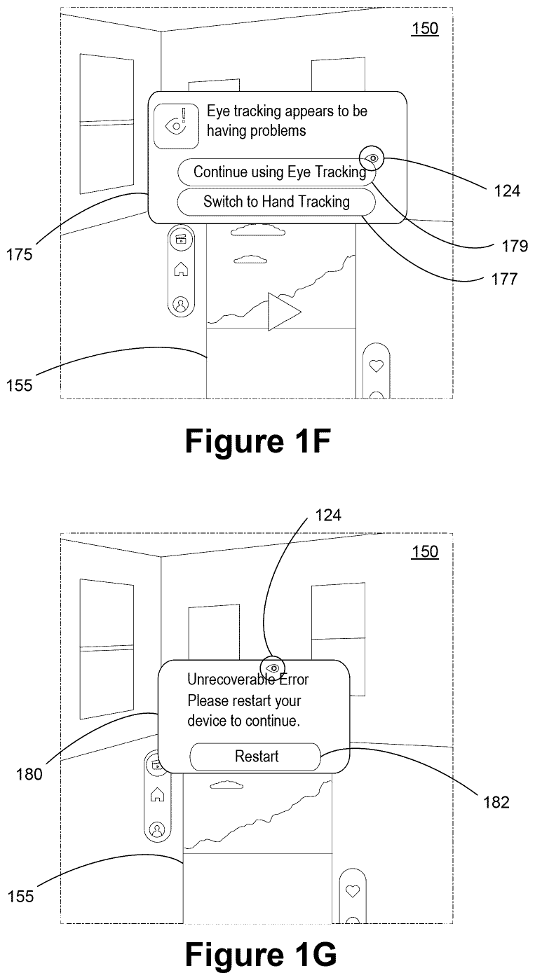

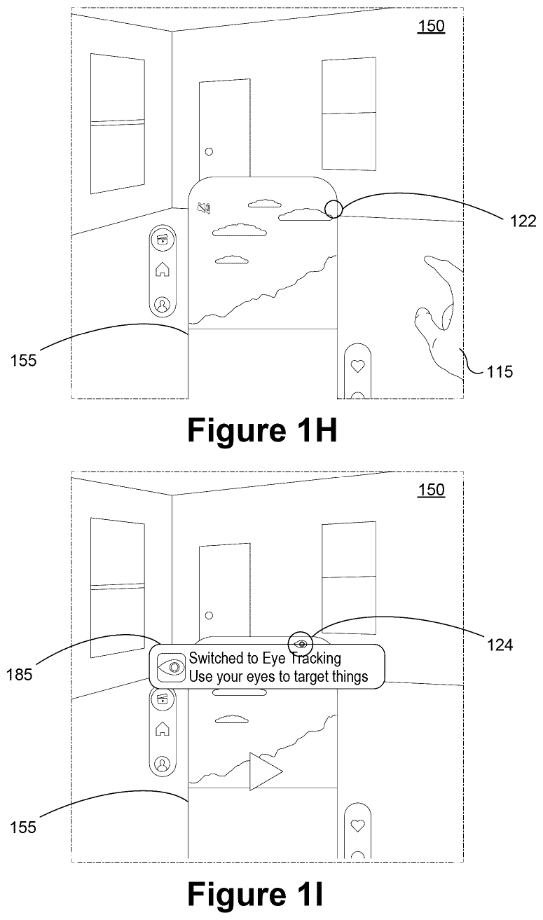

FIGS. 1A-1I illustrate examples of a user 101 interacting with a user interface (UI) 150 presented by a display of a head-wearable device 110 (e.g., a pair of smart glasses, smart contacts, and/or an extended-reality (XR) headset) in response to an automatic change of input methods and/or a requested change of input methods for controlling the head-wearable device 110, in accordance with some embodiments. The head-wearable device 110 includes at least one display (e.g., one display in each of the lenses of the head-wearable device) for displaying the UI 150 to the user 101. The head-wearable device 110 further includes at least one eye-tracking camera (e.g., one eye tracking camera for each eye of the user 101), and/or any other eye-tracking software or hardware, for detecting gaze inputs of the user 101 (e.g., a location of the user's gaze at the display of the head-wearable device). The head-wearable device 110 further includes a forward-facing imaging device (e.g., a camera) for capturing a point-of-view of the user 101 and/or tracking movements of the user's hand(s) 115 and/or detecting hand gestures performed by the user 101. In some embodiments, the head-wearable device 110 is communicatively coupled to a wrist-wearable device 105 (e.g., a smart watch and/or a smart wrist-band). The wrist-wearable device 105 includes one or more sensors (e.g., an electromyography (EMG) sensor and/or an inertial measurement unit (IMU) sensor) for tracking movements of the user's hand(s) 115 (e.g., hand movements of the user 101 (e.g., the hand of the user 101 is outstretched in front of the user 101 while pointing) and/or detecting hand gestures performed by the user 101 (e.g., the user 101 makes a pointing gesture with their index finger)).

In some embodiments, the user 101 performs the gaze inputs, the hand inputs, and/or the hand gestures to control the display of the head-wearable device 110. For example, the user 101 may use either gaze inputs (gaze tracking) or the hand inputs (hand tracking) to target an element (e.g., a button) displayed at the display of the head-wearable device 110 and a hand gesture to select the element. Gaze tracking is based on gaze data, captured at the eye-tracking camera of the head-wearable device 110. Hand tracking is based on image data, captured at the forward-facing camera of the head-wearable device, which captures at least a portion of the user's hand(s) 115. In some embodiments, the head-wearable device 110 and the wrist-wearable device 105 are configured to receive one of the gaze inputs and/or the hand inputs at a time. In some embodiments the head-wearable device 110 and/or the wrist-wearable device 105 are configured to automatically switch between gaze tracking and hand tracking. In some embodiments, the head-wearable device 110 and/or the wrist-wearable device 105 automatically switch between gaze tracking and hand tracking based on a determination that the gaze data and/or the image data is below a respective quality threshold (e.g., the gaze data and/or the image data is too low quality to accurately determine the gaze input and/or the hand input). In some embodiments, the user 101 can manually switch the head-wearable device 110 and/or the wrist-wearable device 105 between gaze tracking and hand tracking (e.g., by interacting with a menu presented at the head-wearable device 110 and/or the wrist-wearable device 105, by interacting with a button and/or a switch of the head-wearable device 110, and/or by performing an input switch command). While the examples herein describe switching between gaze tracking and hand tracking, techniques can also apply to other input modalities (e.g., head-based tracking that is based on IMU data and/or camera data, and/or biopotential tracking that is based on biopotential data).

FIG. 1A illustrates the user 101 using gaze tracking and hand tracking to target in the UI 150. Based on the gaze data, captured at the eye-tracking camera of the head-wearable device 110, a gaze location is determined, and a gaze indicator 124 is displayed at the gaze location in the UI 150. In some embodiments, the gaze indicator 124 is an XR element indicating the gaze location. Based on the image data, captured at the forward-facing camera, a point location is determined, and a hand indicator 122 is displayed at the point location in the UI 150. In some embodiments, the point location is determined based on a location of a tip of a pointing finger of the user's hand 115 (e.g., the point location is the tip of the user's index finger). In some embodiments, the point location is determined based on a projected-point location of the user's hand 115 (e.g., the point location is extrapolated based on a position of the user's hand 115 and/or the pointing finger (e.g., by ray casting)), as illustrated in FIG. 1A. In some embodiments, the hand indicator 122 includes an XR element indicating the point location and/or includes an XR ray portion extending from the user's hand 115 to the point location.

FIGS. 1B-1F illustrate examples of the head-wearable device 110 automatically switching from gaze tracking to hand tracking, in accordance with some embodiments. FIG. 1B illustrates the display of the head-wearable device 110 while performing gaze tracking, in accordance with some embodiments. The head-wearable device 110 displays the UI 150 including one or more UI elements 155 (e.g., a video UI element and two video menu UI elements, as illustrated in FIGS. 1B-1C) and the gaze indicator 124. In response to a determination that the gaze data does not satisfy a gaze-quality threshold, the head-wearable device 110 automatically switches to hand tracking. FIG. 1C illustrates the display of the head-wearable device 110 after automatically switching to hand tracking, in accordance with some embodiments. The head-wearable device 110 displays the UI 150 including the one or more UI elements 155, the hand indicator 122, and a first switching notification 160 (e.g., “Switched to Hand Tracking: Use your hands to target things”) notifying the user 101 that the head-wearable device 110 has switched to hand tracking. In some embodiments, the first switching notification 160 is a visual notification presented at the display of the head-wearable device 110 (e.g., as illustrated in FIG. 1C), an audio notification presented at a microphone of the head-wearable device 110 (e.g., a text-to-speech reading of “Switched to Hand Tracking: Use your hands to target things”), and/or a haptic notification presented at a haptic feedback device of the head-wearable device 110 and/or the wrist-wearable device 105 (e.g., a vibration).

In some embodiments, in response to the determination that the gaze data does not satisfy the gaze-quality threshold, the head-wearable device 110 automatically switches to hand tracking after a predetermined time (e.g., three seconds). FIG. 1D illustrates the display of the head-wearable device 110 after the determining that the gaze data does not satisfy the gaze-quality threshold, in accordance with some embodiments. The head-wearable device 110 displays the UI 150 including the one or more UI elements 155, the gaze indicator 124, and a second switching notification 165 (e.g., “Eye tracking appears to be having problems, Switching to hand tracking in 3 s”) notifying the user 101 that the head-wearable device 110 will switch to hand tracking after the predetermined time. In some embodiments, the second switching notification 165 is a visual notification presented at the display of the head-wearable device 110 (e.g., as illustrated in FIG. 1D), an audio notification presented at the microphone of the head-wearable device 110 (e.g., a text-to-speech reading of “Switching to hand tracking in 3 s.”), and/or a haptic notification presented at the haptic feedback device of the head-wearable device 110 and/or the wrist-wearable device 105 (e.g., a vibration). After the predetermined time elapses, the head-wearable device 110 switches to hand tracking (e.g., as illustrated in FIG. 1C).

In some embodiments, in response to the determination that the gaze data does not satisfy the gaze-quality threshold, the head-wearable device 110 requests that the user 101 switch the head-wearable device 110 to hand tracking. FIG. 1E illustrates the display of the head-wearable device 110 after the determining that the gaze data does not satisfy the gaze-quality threshold, in accordance with some embodiments. The head-wearable device 110 displays the UI 150 including the one or more UI elements 155, the gaze indicator 124, and a third switching notification 170 (e.g., “Eye tracking appears to be having problems”) providing a request to the user 101 to switch the head-wearable device 110 to hand tracking. In some embodiments, the fourth switching notification 170 includes a selectable element 172 (e.g., “Switch to Hand Tracking”) that the user 101 selects (e.g., by gazing at the selectable element 172 and performing a select hand gesture) to switch the head-wearable device 110 to hand tracking. After the user 101 selects the selectable element 172, the head-wearable device 110 switches to hand tracking (e.g., as illustrated in FIG. 1C.

In some embodiments, in response to the determination that the gaze data does not satisfy the gaze-quality threshold, the head-wearable device 110 provides an option to the user 101 switch the head-wearable device 110 to hand tracking. FIG. 1F illustrates the display of the head-wearable device 110 after the determining that the gaze data does not satisfy the gaze-quality threshold, in accordance with some embodiments. The head-wearable device 110 displays the UI 150 including the one or more UI elements 155, the gaze indicator 124, and a fourth switching notification 175 (e.g., “Eye tracking appears to be having problems”) providing an option to the user 101 to switch the head-wearable device 110 to hand tracking. In some embodiments, the fourth switching notification 175 includes a first selectable element 177 (e.g., “Switch to Hand Tracking”) that the user 101 selects (e.g., by gazing at the first selectable element 177 and performing the select hand gesture) to switch the head-wearable device 110 to hand tracking and a second selectable element 179 (e.g., “Continue using Eye Tracking”) that the user 101 selects to keep the head-wearable device 110 in gaze tracking. If the user 101 selects the first selectable element 177, the head-wearable device 110 switches to hand tracking (e.g., as illustrated in FIG. 1C). If the user 101 selects the second selectable element 179, the head-wearable device 110 continues to use gaze tracking (e.g., as illustrated in FIG. 1B).

In some embodiments, in response to response to the determination that the gaze data does not satisfy the gaze-quality threshold and a determination that the image data does not satisfy an image-quality threshold, the head-wearable device 110 provides a request to the user 101 to restart the head-wearable device 110 to hand tracking. FIG. 1G illustrates the display of the head-wearable device 110 after the determining that the gaze data does not satisfy the gaze-quality threshold and determining that the image data does not satisfy the image-quality threshold, in accordance with some embodiments. The head-wearable device 110 displays the UI 150 including the one or more UI elements 155, the gaze indicator 124, and an error notification 180 (e.g., “Unrecoverable Error, Please restart your device to continue”) requesting the user 101 to restart the head-wearable device 110. In some embodiments, the error notification 180 includes another selectable element 182 (e.g., “Restart”) that the user 101 selects (e.g., by gazing at the other selectable element 182 and performing the select hand gesture) to restart the head-wearable device 110. After the user 101 selects the other selectable element 182, the head-wearable device 110 restarts. In some embodiments, the determination that the gaze data does not satisfy the gaze-quality threshold and the determination that the image data does not satisfy an image-quality threshold are made while the head-wearable device 110 is using gaze tracking (e.g., as illustrated in FIG. 1G) and/or while the head-wearable device 110 is using hand tracking (e.g., the user 101 selects the other selectable element 182 by pointing at the other selectable element 182 and performing the select hand gesture). In some embodiments, the user 101 restarts the head-wearable device 110 by pressing a button and/or a switch of the head-wearable device 110.

FIGS. 1H-1I illustrate examples of the head-wearable device 110 automatically switching from hand tracking to gaze tracking, in accordance with some embodiments. FIG. 1H illustrates the display of the head-wearable device 110 while performing hand tracking, in accordance with some embodiments. The head-wearable device 110 displays the UI 150 including one or more UI elements 155 and the hand indicator 122. In response to a determination that the image data does not satisfy image-quality threshold, the head-wearable device 110 automatically switches to gaze tracking. FIG. 1I illustrates the display of the head-wearable device 110 after automatically switching to gaze tracking, in accordance with some embodiments. The head-wearable device 110 displays the UI 150 including the one or more UI elements 155, the gaze indicator 124, and a fifth switching notification 185 (e.g., “Switched to Eye Tracking: Use your eyes to target things”) notifying the user 101 that the head-wearable device 110 has switched to gaze tracking. In some embodiments, the fifth switching notification 185 is a visual notification presented at the display of the head-wearable device 110 (e.g., as illustrated in FIG. 1I), an audio notification presented at the microphone of the head-wearable device 110 (e.g., a text-to-speech reading of “Switched to Eye Tracking: Use your eyes to target things”), and/or a haptic notification presented at the haptic feedback device of the head-wearable device 110 and/or the wrist-wearable device 105 (e.g., a vibration).

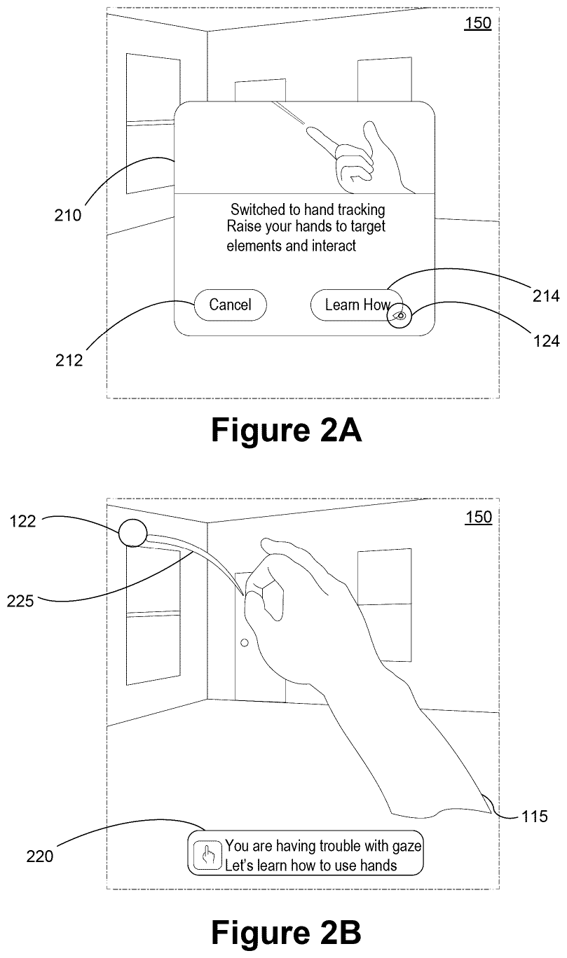

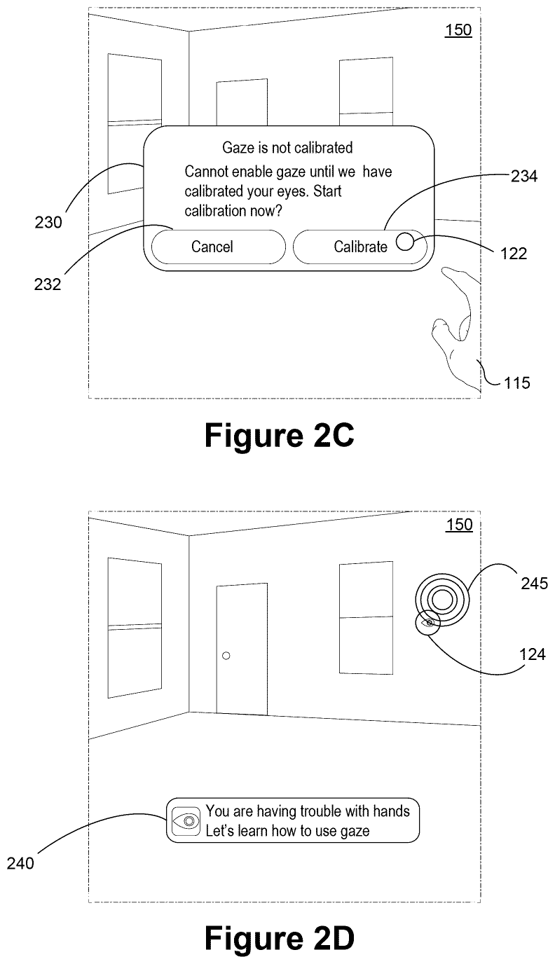

FIGS. 2A-2D illustrates examples of instructions provided to the user 101 to teach the user 101 how to use hand tracking and/or gaze tracking and/or calibrate the head-wearable device 110 and/or wrist-wearable device 105 to accurately determine the point location and/or the gaze location based on the image data and/or the gaze data, respectively, in accordance with some embodiments. In some embodiments, the instructions are automatically presented to the user 101 after the head-wearable device 110 automatically switches to hand tracking and/or gaze tracking, as described in reference to FIGS. 1A-1I.

FIGS. 2A-2B illustrate hand tracking instructions to teach the user 101 how to user hand tracking and/or calibrate the head-wearable device 110 to accurately determine the point location based on the image data, in accordance with some embodiments. In some embodiments, in accordance with a determination that the user 101 is using hand tracking for a first time (e.g., after the head-wearable device 110 automatically switched to hand-tracking, as described in reference to FIGS. 1B-1C) and/or a determination that the head-wearable device 110 is not calibrated for hand tracking with the user 110, the head-wearable device 110 displays the UI 150 including a hand tracking tutorial notification 210 (e.g., “Switched to hand tracking, Raise your hands to target elements and interact”), as illustrated in FIG. 2A. In some embodiments, the hand tracking tutorial notification 210 includes a first selectable element 212 (e.g., “Cancel”) and a second selectable element 214 (e.g., “Learn How”) that the user 101 can select (e.g., by gazing at the first selectable element 212 and/or the second selectable element 214 and performing the select hand gesture) at the head-wearable device 110. If the user 101 selects the first selectable element 212, the head-wearable device 110 continues to use gaze tracking. If the user 101 selects the second selectable element 214, the head-wearable device 110 begins a hand tracking tutorial/calibration session. FIG. 2B illustrates the head-wearable device 110 displaying the UI 150 including the hand tracking tutorial/calibration session, in accordance with some embodiments. In some embodiments, the hand tracking tutorial/calibration session includes one or more XR elements (e.g., instructional message element 220 and/or instructional visual element 225) that teach the user 101 how to user hand tracking and/or calibrate the head-wearable device 110 to accurately determine the point location based on the image data.

FIGS. 2C-2D illustrate gaze tracking instructions to teach the user 101 how to user gaze tracking and/or calibrate the head-wearable device 110 to accurately determine the gaze location based on the gaze data, in accordance with some embodiments. In some embodiments, in accordance with a determination that the user 101 is using gaze tracking for a first time (e.g., after the head-wearable device 110 automatically switched to gaze-tracking, as described in reference to FIGS. 1H-1I) and/or a determination that the head-wearable device 110 is not calibrated for gaze tracking with the user 110, the head-wearable device 110 displays the UI 150 including a gaze tracking tutorial notification 230 (e.g., “Gaze is not calibrated, Cannot enable gaze until we have calibrated your eyes. Start calibration now?”), as illustrated in FIG. 2C. In some embodiments, the hand tracking tutorial notification 230 includes a first selectable element 232 (e.g., “Cancel”) and a second selectable element 234 (e.g., “Calibrate”) that the user 101 can select (e.g., by gazing at the first selectable element 232 and/or the second selectable element 234 and performing the select hand gesture) at the head-wearable device 110. If the user 101 selects the first selectable element 232, the head-wearable device 110 continues to use hand tracking. If the user 101 selects the second selectable element 234, the head-wearable device 110 begins a gaze tracking tutorial/calibration session. FIG. 2D illustrates the head-wearable device 110 displaying the UI 150 including the gaze tracking tutorial/calibration session, in accordance with some embodiments. In some embodiments, the gaze tracking tutorial/calibration session includes one or more other XR elements (e.g., instructional message element 240 and/or instructional visual element 245) that teach the user 101 how to user gaze tracking and/or calibrate the head-wearable device 110 to accurately determine the gaze location based on the gaze data.

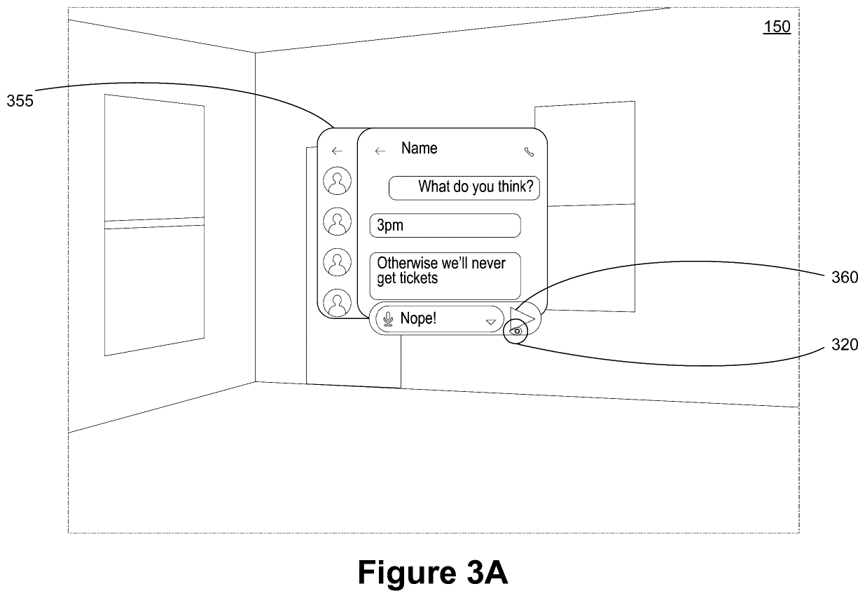

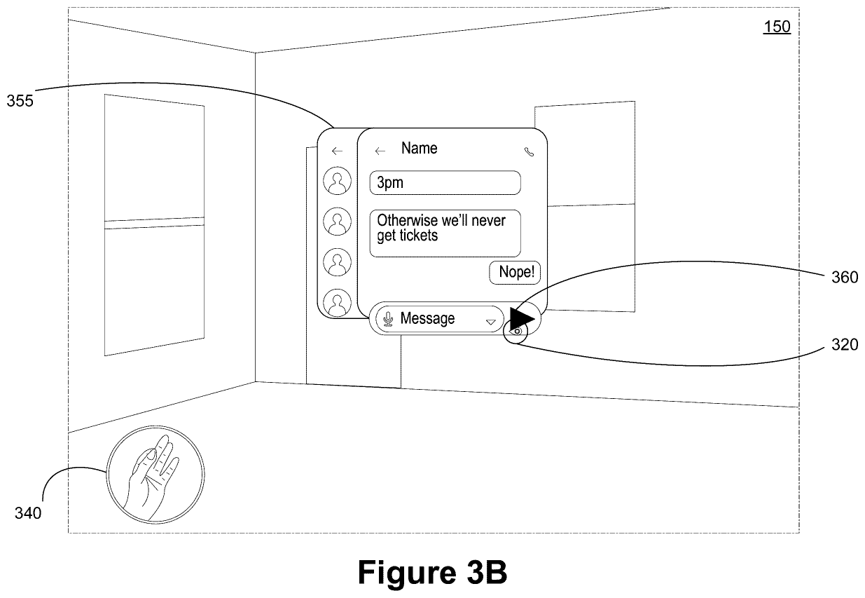

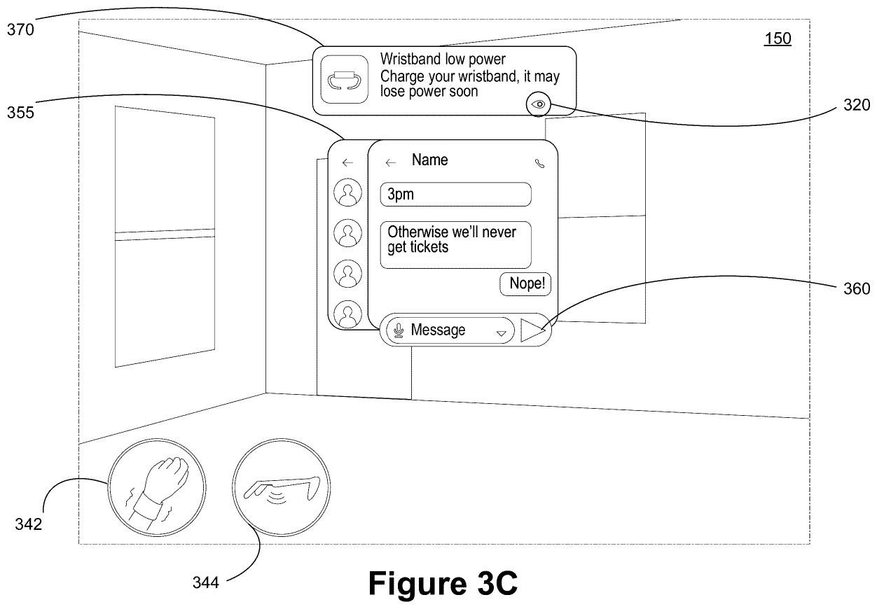

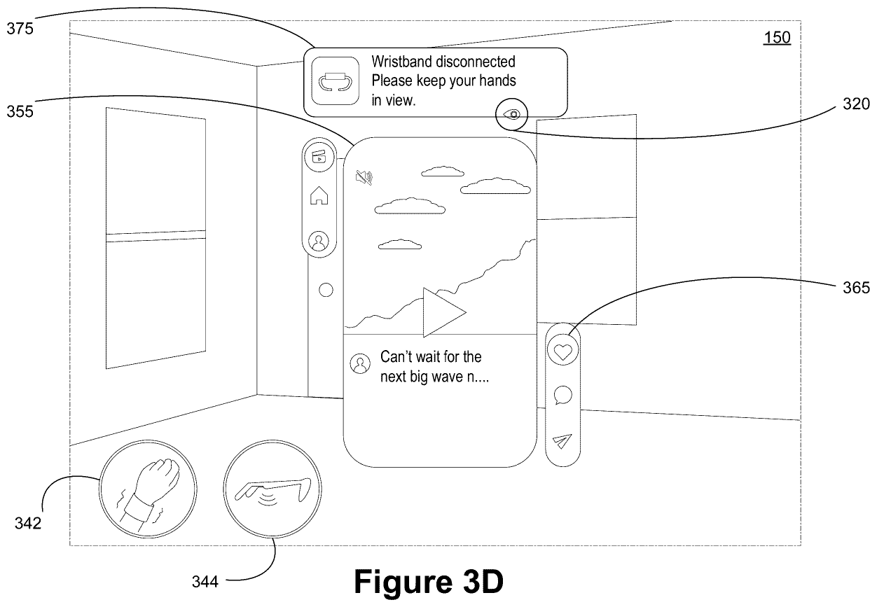

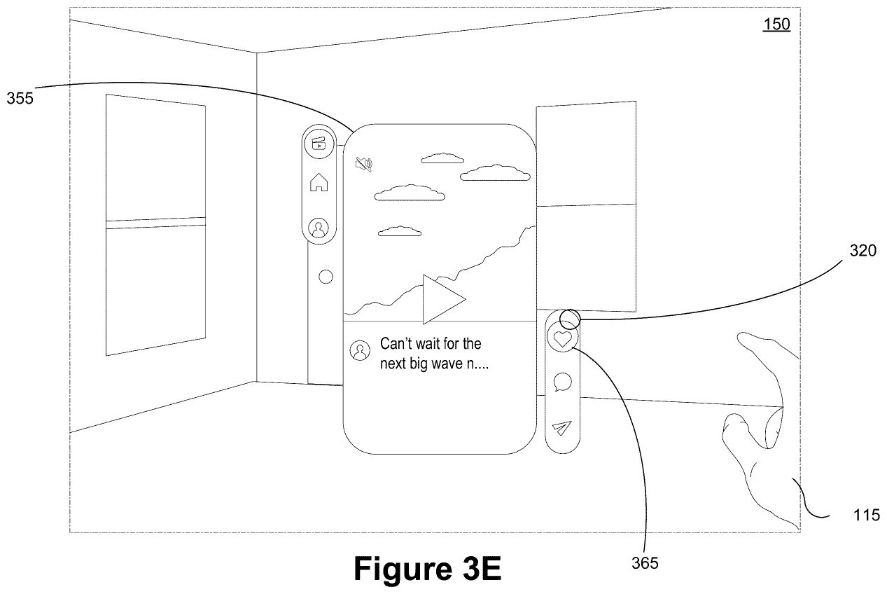

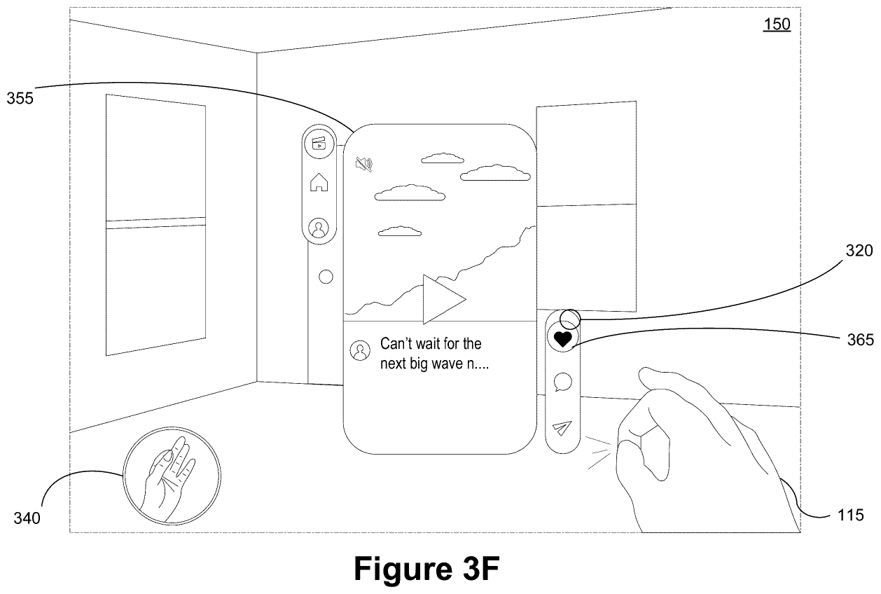

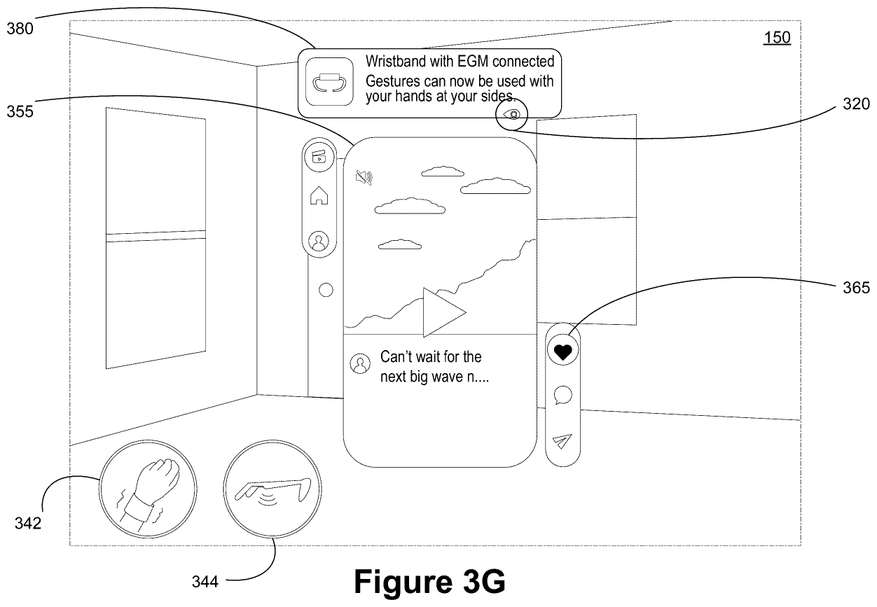

FIGS. 3A-3G illustrate a sequence of the head-wearable device 110 and/or the wrist-wearable device 105 automatically switching from biopotential gesture tracking to image gesture tracking to detect hand gestures for interacting with the head-wearable device 110, in accordance with some embodiments. In some embodiments, the head-wearable device 110 and/or the wrist-wearable device 105 determines whether the user 101 has performed a hand gesture (e.g., the select gesture) based on biopotential data (e.g., EMG data) captured at the one or more sensors of the wrist-wearable device 105 and/or the image data captured by the forward-facing camera of the head-wearable device, which captures at least a portion of the user's hand(s) 115. In some embodiments, based on the biopotential data and/or the image data, the head-wearable device 110 and/or the wrist-wearable device 105 determines that the user 101 has performed at least one of a plurality of in-air hand gestures (e.g., an index finger pinch, a middle finger pinch, an index finger double pinch, a wrist-roll, a finger snap, a finger flick, a balled fist, and/or any other finger or wrist movement). In some embodiments, the head-wearable device 110 and/or the wrist-wearable device 105 automatically switch between biopotential gesture tracking and image gesture tracking based on a determination that the biopotential data and/or the image data is below a respective quality threshold (e.g., the biopotential data and/or the image data is too low quality to accurately determine the hand gestures performed by the user 101). In some embodiments, the head-wearable device 110 and/or the wrist-wearable device 105 automatically switch between biopotential gesture tracking and image gesture tracking based on a determination that the wrist-wearable device 105 has a battery level above and/or below a battery threshold value and/or the wrist-wearable device 105 is connected and/or disconnected with the head-wearable device 110. In some embodiments, the user 101 can manually switch the head-wearable device 110 and/or the wrist-wearable device 105 between biopotential gesture tracking and image gesture tracking (e.g., by interacting with a menu presented at the head-wearable device 110 and/or the wrist-wearable device 105, by interacting with a button and/or a switch of the head-wearable device 110 and/or the wrist-wearable device 105, and/or by performing a gesture input switch command). Biopotential gesture tracking and image gesture tracking can both be used in conjunction with both of gaze tracking and hand tracking to target and select XR elements presented at the UI 150.

FIG. 3A illustrates the display of the head-wearable device 110 while performing biopotential gesture tracking, in accordance with some embodiments. The head-wearable device 110 displays the UI 150 including one or more other UI elements 355 (e.g., a texting UI element, as illustrated in FIGS. 3A-3C), including at least one selectable UI element 360 (e.g., a send text button), and a targeting indicator 320 (e.g., the gaze indicator 124, as illustrated in FIGS. 3A-3D and 3G, and/or the hand indicator 122). FIG. 3B illustrates the display of the head-wearable 110 when the user 101 performs the select gesture (e.g., an index finger pinch gesture) with biopotential gesture tracking, in accordance with some embodiments. In accordance with a determination that the user 101 is targeting a selectable UI element 360 and a determination, based on the biopotential data, that the user 101 performed the select gesture, the selectable UI element 360 is selected (e.g., the send text button is pressed). In some embodiments, when the selectable UI element 360 is selected, at least one quality of the selectable UI element 360 (e.g., a color, a brightness, and/or a shape of the selectable UI element 360) changes to indicate to the user 101 has selected the selectable UI element 360, as illustrated in FIG. 3B. In some embodiments, based on the selectable UI element 360, the head-wearable device 110 and/or the wrist-wearable device 105 performs one or more tasks (e.g., sends a text message). In some embodiments, in accordance with the determination, based on the biopotential data, that the user 101 performed the select gesture, a gesture indicator 340 is presented at the UI 150 to indicate to the user 101 that the head-wearable device 110 and/or the wrist-wearable device 105 detected the select gesture.

FIG. 3C illustrates the display of the head-wearable 110 when the battery level of the wrist-wearable device 105 is below the battery threshold value (e.g., ten percent), in accordance with some embodiments. In accordance with a determination that the battery level of the wrist-wearable device 105 is below the battery threshold value, a low-battery notification 370 (e.g., Wristband low power, Charge your wristband, it may lose power soon) is presented at the UI 150. In some embodiments, the low-battery notification 370 is a visual notification presented at the display of the head-wearable device 110 (e.g., as illustrated in FIG. 3C), an audio notification presented at the microphone of the head-wearable device 110 (e.g., a text-to-speech reading of “Wristband low power, Charge your wristband”), and/or a haptic notification presented at the haptic feedback device of the head-wearable device 110 and/or the wrist-wearable device 105 (e.g., a vibration). In some embodiments, an audio notification indicator 342 is presented at the UI 150 to indicate to the user 101 that the audio notification is being presented. In some embodiments, a haptic notification indicator 344 is presented at the UI 150 to indicate to the user 101 that the haptic notification is being presented.

FIG. 3D illustrates the display of the head-wearable 110 when the wrist-wearable device 105 disconnects from the head-wearable device 110 (e.g., because the battery level of the wrist-wearable device 105 reached zero), in accordance with some embodiments. In accordance with a determination that the wrist-wearable device 105 is disconnected from the head-wearable device 110, the head-wearable device 110 automatically switches to image gesture tracking. In some embodiments, in accordance with the determination that the wrist-wearable device 105 is disconnected from the head-wearable device 110, the head-wearable device 110 presents a first switching notification 375 (e.g., “Wristband disconnected, Please keep your hands in view.”) at the UI 150, notifying the user 101 that the head-wearable device 110 has switched to image gesture tracking. In some embodiments, the first switching notification 375 is a visual notification, an audio notification, including the audio notification indicator 342, and/or a haptic notification, including the haptic notification indicator 344. In some embodiments, when the head-wearable device 110 automatically switches from biopotential gesture tracking to image gesture tracking, the head-wearable device 110 will also automatically switch from gaze tracking to hand tracking.

FIG. 3E illustrates the display of the head-wearable device 110 while performing image gesture tracking, in accordance with some embodiments. The head-wearable device 110 displays the UI 150 including the one or more other UI elements 355 (e.g., a texting UI element, as illustrated in FIGS. 3D-3G), including at least one other selectable UI element 365 (e.g., a like button), and the targeting indicator 320 (e.g., the gaze indicator 124 and/or the hand indicator 122, as illustrated in FIGS. 3E-3F). FIG. 3F illustrates the display of the head-wearable 110 when the user 101 performs the select gesture (e.g., an index finger pinch gesture) with image gesture tracking, in accordance with some embodiments. In accordance with a determination that the user 101 is targeting another selectable UI element 365 and a determination, based on the image data, that the user 101 performed the select gesture, the other selectable UI element 365 is selected (e.g., the like button is pressed). In some embodiments, when the other selectable UI element 365 is selected, at least one quality of the other selectable UI element 365 changes to indicate to the user 101 has selected the other selectable UI element 365, as illustrated in FIG. 3F. In some embodiments, based on the other selectable UI element 365, the head-wearable device 110 performs one or more tasks (e.g., likes a social media post). In some embodiments, in accordance with the determination, based on the image data, that the user 101 performed the select gesture, the gesture indicator 340 is presented at the UI 150 to indicate to the user 101 that the head-wearable device 110 detected the select gesture.

FIG. 3G illustrates the display of the head-wearable 110 when the wrist-wearable device 105 connects (or reconnects) to the head-wearable device 110, in accordance with some embodiments. In accordance with a determination that the wrist-wearable device 105 is connected to the head-wearable device 110, the head-wearable device 110 automatically switches to biopotential gesture tracking. In some embodiments, in accordance with the determination that the wrist-wearable device 105 is connected to the head-wearable device 110, the head-wearable device 110 presents a second switching notification 380 (e.g., “Wristband with EMG connected, Gestures can now be used with your hands at your sides.”) at the UI 150, notifying the user 101 that the head-wearable device 110 has switched to biopotential gesture tracking. In some embodiments, the second switching notification 380 is a visual notification, an audio notification, including the audio notification indicator 342, and/or a haptic notification, including the haptic notification indicator 344. In some embodiments, when the head-wearable device 110 automatically switches from image gesture tracking to biopotential gesture tracking, the head-wearable device 110 will also automatically switch from hand tracking to gaze tracking.

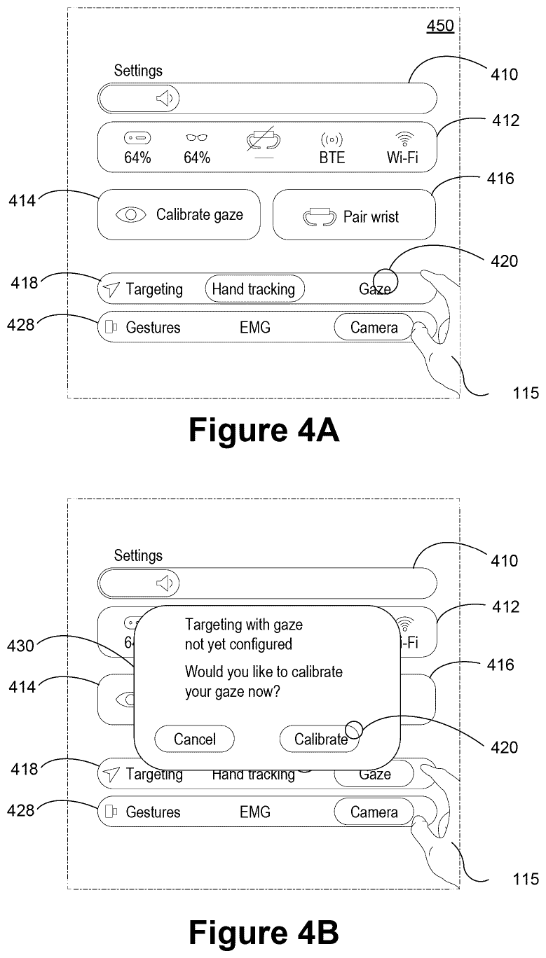

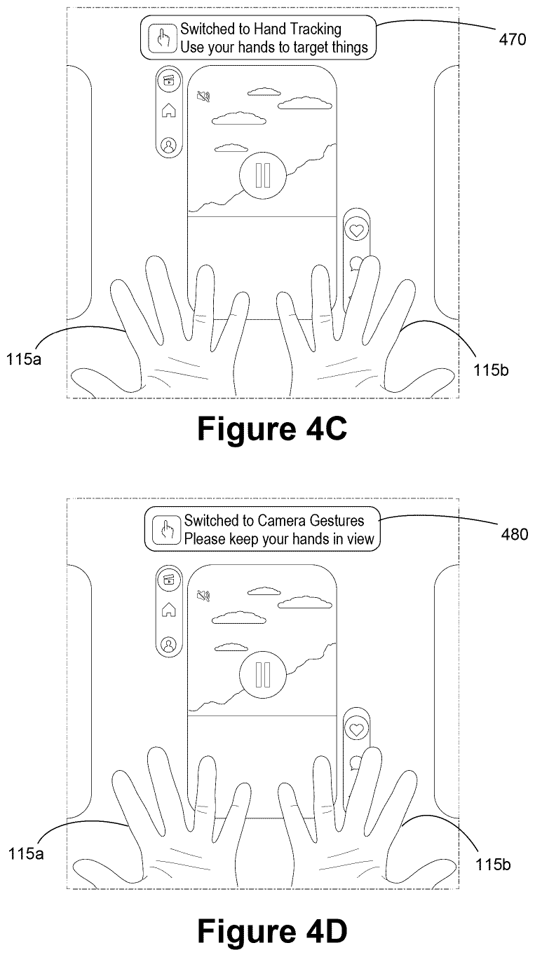

FIGS. 4A-4D illustrate the user 101 manually switching the head-wearable device 110 and/or the wrist-wearable device 105 between gaze tracking and hand tracking and/or the user 101 manually switching the head-wearable device 110 and/or the wrist-wearable device 105 between biopotential gesture tracking and image gesture tracking, in accordance with some embodiments. FIGS. 4A-4B illustrate a settings UI 450 presented at the display of the head-wearable device 110, in accordance with some embodiments. In some embodiments, the settings UI 450 includes volume adjustment element 410 (e.g., a slider, as illustrated in FIGS. 4A-4B) for changing a volume of one or more speakers of the head-wearable device 110, the wrist-wearable device, and/or another communicatively coupled device (e.g., a handheld intermediary processing device, a smartphone, a smart television, wireless speakers, wireless headphones). In some embodiments, the settings UI 450 includes one or more device management elements 412. In some embodiments, the one or more device management elements 412 includes an other device indicator, indicating whether the other communicatively coupled device is connected to the head-wearable device 110 and a battery level of the other communicatively coupled device, a head-wearable device indicator, indicating a battery level of the head-wearable device 110, a wrist-wearable device indicator, indicating whether the wrist-wearable device 105 is connected to the head-wearable device 110 and the battery level of the wrist-wearable device 105, a Bluetooth indicator, indicating a Bluetooth connectivity of the head-wearable device 110, and a WiFi indicator, indicating a WiFi connectivity of the head-wearable device 110. In some embodiments, the settings UI 450 includes a gaze calibration option 414, that, when selected, begins a gaze tracking calibration session at the head-wearable device 110. In some embodiments, the settings UI 450 includes a wrist-wearable device pairing option 416, that, when selected, causes the head-wearable device 110 to search for a wrist-wearable device 105 to connectively couple with. In some embodiments, the settings UI 450 includes a targeting option selector 418, that allows the user 101 to select between a gaze tracking option and a hand tracking option. In some embodiments, the settings UI 450 includes a gesture tracking option selector 428, that allows the user 101 to select between a biopotential gesture tracking option and an image gesture tracking option.

In some embodiments, the user 101 interacts with the settings UI 450 using gaze tracking and/or hand tracking and biopotential gesture tracking and/or image gesture tracking. For example, FIG. 4A illustrates the user 101 using hand tracking and image gesture tracking to interact with the settings UI 450. As an example the user 101 switches from hand tracking to gaze tracking by moving a targeting indicator 420 (e.g., the gaze indicator 124 and/or the hand indicator 122, as illustrated in FIGS. 4A-4B) over the gaze tracking option of the targeting option selector 418. The user 101 performs the select gesture (e.g., an index finger pinch) to select the gaze tracking option. In response to the user 101 selecting the gaze tracking option, the head-wearable device 110 switches to gaze tracking and presents a switching notification (e.g., the fifth switching notification 185, described in reference to FIG. 1I). In some embodiments, in accordance with the determination that the user 101 is using gaze tracking for a first time and/or the determination that the head-wearable device 110 is not calibrated for gaze tracking with the user 110 (e.g., as described in reference to FIGS. 2C-2D), the head-wearable device 110 presents a gaze tracking tutorial notification 430 (e.g., “Targeting with gaze not yet configured, Would you loke to calibrate your gaze now?”), as illustrated in FIG. 4B.

FIG. 4C illustrates the user 101 performing an input switch command to manually switch the head-wearable device 110 between gaze tracking and hand tracking, in accordance with some embodiments. In some embodiments, the input switch command is a hand gesture (e.g., as illustrated in FIG. 4C), a voice command (e.g., “Switch to hand tracking”), and a button press. In some embodiments, the user 101 performs a first input switch command to manually switch head-wearable device 110 from gaze tracking to hand tracking (e.g., the user 101 holds both of the user's hands 115a-115b in front of the head-wearable device 110 with the palms facing the head-wearable device for a predetermined period of time (e.g., five seconds), as illustrated in FIG. 4C) and a second input switch command to manually switch head-wearable device 110 from hand tracking to gaze tracking (e.g., the user 101 holds both of the user's hands 115a-115b in front of the head-wearable device 110 with the palms facing away from the head-wearable device 110 for the predetermined period of time). In response to the user 101 performing the input switch command, the head-wearable device 110 switches to gaze tracking and/or hand tracking and presents a switching notification 470 (e.g., the first switching notification 160 and/or the fifth switching notification 185, respectively) to indicate to the user 101 that the head-wearable device 110 has switched to gaze tracking and/or hand tracking, respectively.

FIG. 4D illustrates the user 101 performing a gesture input switch command to manually switch the head-wearable device 110 between biopotential gesture tracking and image gesture tracking, in accordance with some embodiments. In some embodiments, the gesture input switch command is a hand gesture (e.g., as illustrated in FIG. 4D), a voice command (e.g., “Switch to image gesture tracking”), and a button press. In some embodiments, the user 101 performs a first gesture input switch command to manually switch head-wearable device 110 from biopotential gesture tracking to image gesture tracking (e.g., the user 101 holds both of the user's hands 115a-115b in front of the head-wearable device 110 with the palms facing the head-wearable device 110 for a predetermined period of time (e.g., five seconds), as illustrated in FIG. 4D) and a second gesture input switch command to manually switch head-wearable device 110 from image gesture tracking to biopotential gesture tracking (e.g., the user 101 holds both of the user's hands 115a-115b in front of the head-wearable device 110 with the palms facing away from the head-wearable device 110 for the predetermined period of time). In response to the user 101 performing the gesture input switch command, the head-wearable device 110 switches to biopotential gesture tracking and/or image gesture tracking and presents a gesture switching notification 480 (e.g., the first switching notification 375 and/or the second switching notification 380, respectively) to indicate to the user 101 that the head-wearable device 110 has switched to biopotential gesture tracking and/or image gesture tracking, respectively.

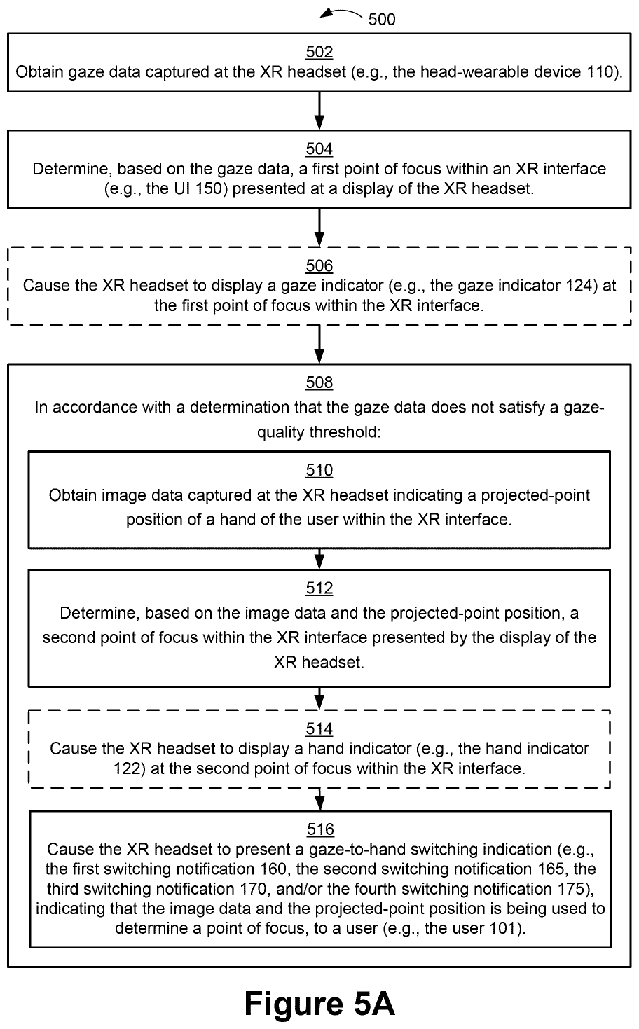

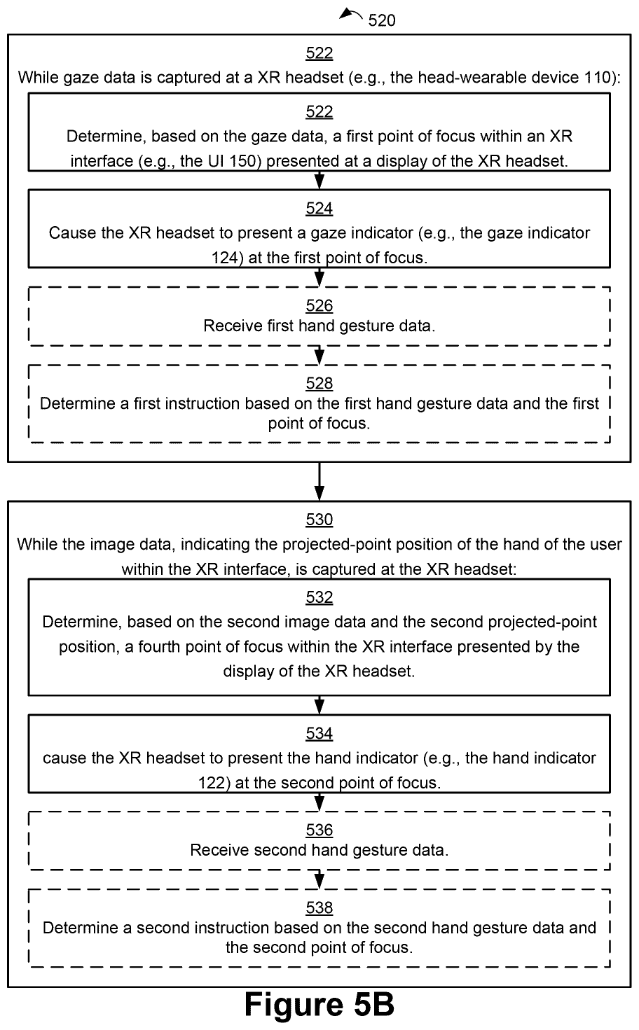

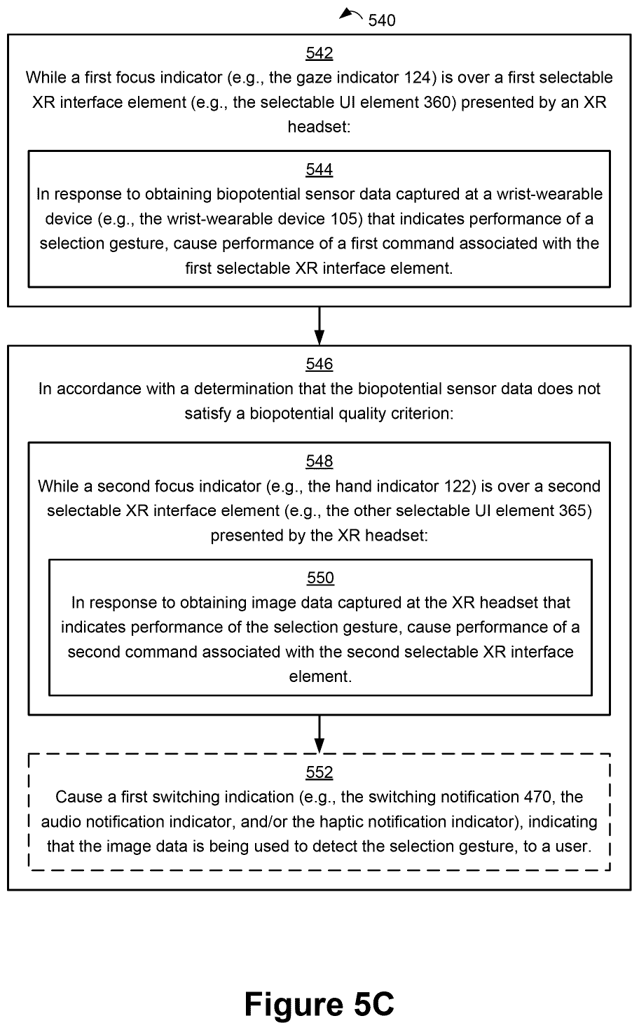

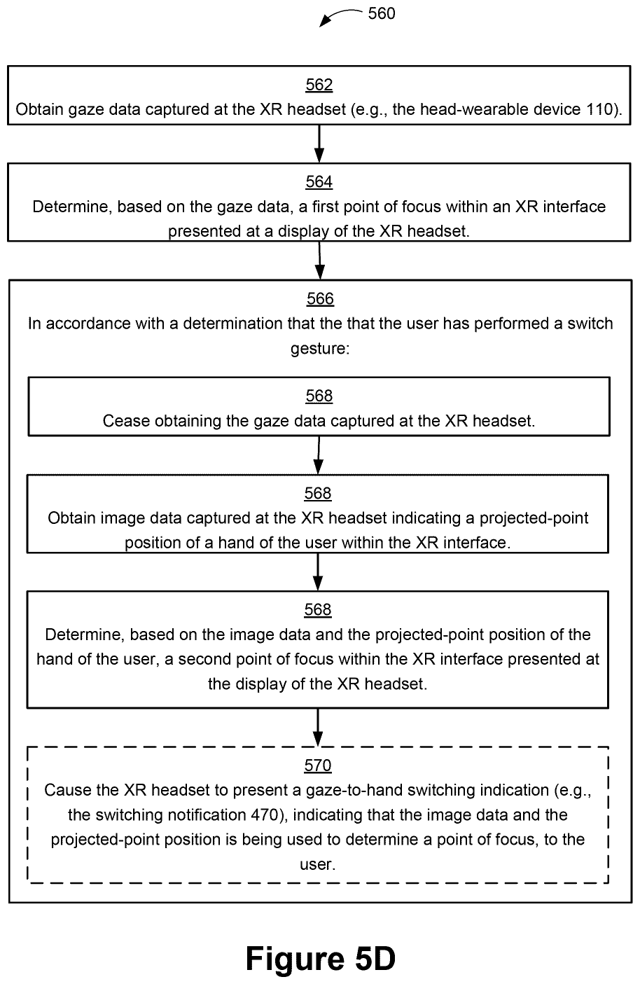

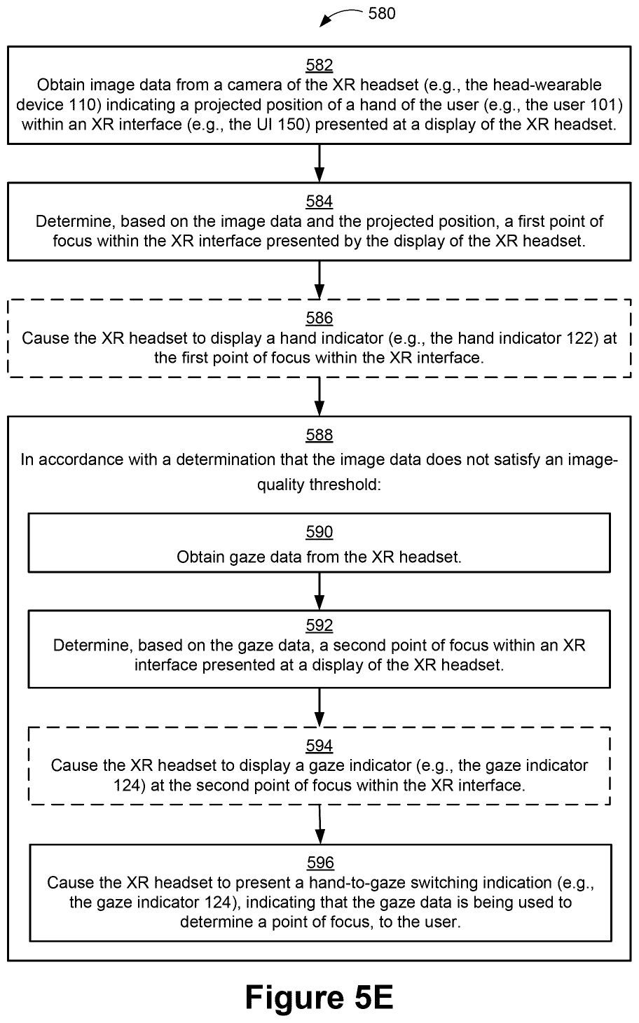

(A1) FIG. 5A illustrates a flow chart of a first method 500 for automatic switching from gaze tracking to hand tracking, in accordance with some embodiments.

The first method 500 occurs at an extended-reality (XR) headset (e.g., the head-wearable device 110) with one or more gaze-tracking devices (e.g., the eye-tracking camera), one or more cameras (e.g., the forward-facing camera), and/or one or more displays (e.g., the display of the head-wearable device 110) worn by a user (e.g., the user 101). In some embodiments, the first method 500 occurs while the XR headset is worn by the user. The first method 500 includes obtaining gaze data captured at the XR headset (502). The first method 500 further includes determining, based on the gaze data, a first point of focus (e.g., the gaze location) within an XR interface (e.g., the UI 150) presented at a display of the XR headset (504). The first method 500 further includes, in accordance with a determination that the gaze data does not satisfy a gaze-quality threshold (508): (i) obtaining image data captured at the XR headset indicating a projected-point position of a hand of the user within the XR interface (510), and (ii) determining, based on the image data and the projected-point position, a second point of focus (e.g., the point location) within the XR interface presented by the display of the XR headset (512). The first method 500 further includes, in accordance with the determination that the gaze data does not satisfy the gaze-quality threshold, causing the XR headset to present a gaze-to-hand switching indication (e.g., the first switching notification 160, the second switching notification 165, the third switching notification 170, and/or the fourth switching notification 175), indicating that the image data and the projected-point position is being used to determine a point of focus, to the user (516).

(A2) In some embodiments of A2, the first method 500 further includes, after determining the second point of focus within the XR interface presented by the display of the XR headset, causing the XR headset to display a hand indicator (e.g., the gaze indicator 124) at the second point of focus within the XR interface (506).

(A3) In some embodiments of any of A1-A2, the first method 500 further includes, in accordance with the determination that the gaze data does not satisfy the gaze-quality threshold and after determining the second point of focus within the XR interface presented by the display of the XR headset, cause the XR headset to display a hand indicator (e.g., the hand indicator 122) at the second point of focus within the XR interface (514).

(A4) In some embodiments of any of A1-A3, the gaze-to-hand switching indication includes at least one of a haptic indication presented by a haptic device communicatively coupled to the one or more processors, an audio indication presented by a speaker communicatively coupled to the one or more processors, and a visual indication presented by a display communicatively coupled to the one or more processors.

(A5) In some embodiments of any of A1-A4, the gaze-to-hand switching indication includes one or more selectable options (e.g., the selectable element 172, the first selectable element 177, and/or the second selectable element 179). Additionally, obtaining the image data from the camera of the XR headset indicating the projected-point position of the hand of the user within the XR interface and determine, based on the image data and the projected-point position, the first point of focus within the XR interface presented by the display of the XR headset is further in accordance with a determination that the user selects a first option (e.g. the selectable element 172 and/or the first selectable element 177) of the one or more selectable options.

(A6) In some embodiments of any of A1-A5, the first method 500 further includes, in accordance with the determination that the gaze data does not satisfy the gaze-quality threshold and a determination that the user selects a second option (e.g., the second selectable element 179) of the one or more selectable options, (i) obtaining other gaze data from the XR headset and (ii) determining, based on the other gaze data, another point of focus within the XR interface presented by the display of the XR headset.

(A7) In some embodiments of any of A1-A6, the first method 500 further includes, in accordance with a determination that the image data does not satisfy an image-quality threshold, (i) obtaining second gaze data captured at the XR headset and (ii) determining, based on the second gaze data, a third point of focus within the XR interface presented by the display of the XR headset.

(A8) In some embodiments of any of A1-A7, the first method 500 further includes, in accordance with the determination that the gaze data does not satisfy the gaze-quality threshold, cause the XR headset to a hand-to-gaze switching indication (e.g., the fifth switching notification 185), indicating that the second gaze data is being used to determine a point of focus, to the user.

(A9) In some embodiments of any of A1-A8, the first method 500 further includes, (i), after determining the first point of focus within the XR interface presented by the display of the XR headset, obtaining third gaze data captured at the XR headset and (ii) determining, based on the third gaze data, a fourth point of focus within the XR interface presented by the display of the XR headset.

(A10) In some embodiments of any of A1-A9, the first method 500 further includes, in accordance with the determination that the gaze data does not satisfy the gaze-quality threshold, (i), after determining the second point of focus within the XR interface presented by the display of the XR headset, obtaining second image data captured at the XR headset indicating a second projected position of the hand of the user within the XR interface and (ii) determining, based on the second image data and the second projected position, a fifth point of focus within the XR interface presented by the display of the XR headset.

(A11) In some embodiments of any of A1-A10, the first method 500 further includes, before obtaining the gaze data captured at the XR headset and in accordance with a determination that the XR headset is not configured to detect the gaze data from the user, (i) causing the XR headset to present a gaze configuration request (e.g., the gaze tracking tutorial notification 230) to the user and (ii), in accordance with a determination that the user accepts the gaze configuration request, causing the XR headset to be configured to detect the gaze data from the user (e.g., as described in reference to FIG. 2D).

(A12) In some embodiments of any of A1-A11, the first method 500 further includes, in accordance with the determination that the gaze data does not satisfy a gaze-quality threshold, before obtaining the image data captured at the XR headset indicating the projected-point position of the hand of the user within the XR interface, and in accordance with a determination that the XR headset is not configured to detect the image data from the user, (i) causing the XR headset to present a hand tutorial request (e.g., the hand tracking tutorial notification 210) to the user and (ii), in accordance with a determination that the user accepts the hand tutorial request, causing the XR headset to present a hand-detection tutorial to the user (e.g., as described in reference to FIG. 2B).

(A13) In some embodiments of any of A1-A12, the first method 500 further includes, in accordance with the determination that the gaze data does not satisfy the gaze quality threshold and in accordance with a determination that the image data does not satisfy an image quality threshold, causing the XR headset to present a restart indication (e.g., the error notification 180), requesting the user to restart the AR headset, to the user.

(A14) In some embodiments of any of A1-A13, the first method 500 further includes, after determining the first point of focus within the XR interface presented by the display of the XR headset, (i) obtaining hand gesture data and (ii) determining an instruction based on the hand gesture data and the first point of focus. The first method 500 further includes, in accordance with the determination that the gaze data does not satisfy the gaze quality threshold and after determining the second point of focus within the XR interface presented by the display of the XR headset, (i) obtaining other hand gesture data and (ii) determining another instruction based on the other hand gesture data and the second point of focus.

(A15) In some embodiments of any of A1-A14, the gaze data is captured at an eye-tracking camera of the XR headset, and the image data is captured at a camera of the XR headset.

(A16) In some embodiments of any of A1-A15, the first method 500 further includes, the XR headset is at least one of a pair of smart glasses, smart contacts, and an augmented-reality (AR) headset.

(B1) FIG. 5B illustrates a flow chart of a second method 520 for presenting gaze tracking indicators and hand tracking indicators, in accordance with some embodiments.

The second method 520 occurs at an XR headset (e.g., the head-wearable device 110) with one or more gaze-tracking devices (e.g., the eye-tracking camera), one or more cameras (e.g., the forward-facing camera), and/or one or more displays (e.g., the display of the head-wearable device 110) worn by a user (e.g., the user 101). In some embodiments, the second method 520 occurs while the XR headset is worn by the user. The second method 520 includes, while gaze data is captured at the XR headset (522): (i) determining, based on the gaze data, a first point of focus (e.g., the gaze location) within an XR interface (e.g., the UI 150) presented at a display of the XR headset (522) and (ii) causing the XR headset to present a gaze indicator (e.g., the gaze indicator 122) at the first point of focus (524). The second method 520 further includes, while image data, indicating a projected-point position of a hand of the user within the XR interface, is captured at the XR headset (530): (i) determining, based on the image data and the projected-point position, a second point of focus (e.g., the point location) within the XR interface presented by the display of the XR headset (532) and (ii) causing the XR headset to present a hand indicator (e.g., the hand indicator 122) at the second point of focus (534).

(B2) In some embodiments of B1, the gaze indicator and the hand indicator are visually distinct.

(B3) In some embodiments of any of B1-B2, the second method 520 further includes, while second gaze data is captured at the XR headset: (i) determining, based on the second gaze data, a third point of focus within the XR interface presented by the display of the XR headset and (ii) causing the XR headset to present the gaze indicator at the third point of focus. The second method 520 further includes, while second image data, indicating a second projected-point position of the hand of the user within the XR interface, is captured at the XR headset: (i) determining, based on the second image data and the second projected-point position, a fourth point of focus within the XR interface presented by the display of the XR headset and (ii) causing the XR headset to present the hand indicator at the second point of focus.

(B4) In some embodiments of any of B1-B3, the second method 320 further includes, while the gaze data is captured at the XR headset: (i) receiving first hand gesture data (526) and (ii) determining a first instruction based on the first hand gesture data and the first point of focus (528). The second method 520 further includes, while the image data, indicating the projected-point position of the hand of the user within the XR interface, is captured at the XR headset: (i) receiving second hand gesture data (536) and (ii) determining a second instruction based on the second hand gesture data and the second point of focus (538).

(B5) In some embodiments of any of B1-B4, the gaze data is captured at an eye-tracking camera of the XR headset, and the image data is captured at a camera of the XR headset.

(B6) In some embodiments of any of B1-B5, the XR headset is at least one of a pair of smart glasses and an augmented-reality (AR) headset.

(C1) FIG. 5C illustrates a flow chart of a third method 540 for automatically switching between biopotential hand gesture tracking and image hand gesture tracking, in accordance with some embodiments.

The third method 540 occurs at an XR headset (e.g., the head-wearable device 110) with one or more gaze-tracking devices (e.g., the eye-tracking camera), one or more cameras (e.g., the forward-facing camera), and/or one or more displays (e.g., the display of the head-wearable device 110) and a wrist-wearable device (e.g., the wrist-wearable device 105) including one or more biopotential sensors (e.g., one or more EMG sensors) worn by a user (e.g., the user 101). In some embodiments, the third method 540 includes, while a first focus indicator (e.g., the targeting indicator 320) is over a first selectable XR interface element (e.g., the selectable UI element 360) presented by an XR headset (542) and in response to obtaining biopotential sensor data captured at the wrist-wearable device that indicates performance of a selection gesture, causing performance of a first command associated with the first selectable XR interface element (544). The third method 540 further includes, in accordance with a determination that the biopotential sensor data does not satisfy a biopotential quality criterion (546), while a second focus indicator (e.g., the targeting indicator 320) is over a second selectable XR interface element (e.g., the other selectable UI element 365) presented by the XR headset (548), and in response to obtaining image data captured at the XR headset that indicates performance of the selection gesture, causing performance of a second command associated with the second selectable XR interface element (550).

(C2) In some embodiments of C1, the method 540 further includes, in accordance with the determination that the biopotential sensor data does not satisfy the biopotential quality criterion, causing a first switching indication (e.g., the switching notification 470, the audio notification indicator, and/or the haptic notification indicator), indicating that the image data is being used to detect the selection gesture, to a user (552).

(C3) In some embodiments of any of C1-C2, the first switching indication includes at least one of a haptic indication presented by a haptic device communicatively coupled to the one or more processors, an audio indication presented by a speaker communicatively coupled to the one or more processors, and a visual indication presented by a display communicatively coupled to the one or more processors.

(C4) In some embodiments of any of C1-C3, the third method 340 further includes, in accordance with a determination that the image data does not satisfy an image quality criterion, while a third focus indicator is over a third selectable XR interface element presented by the XR headset, and in response to obtaining second biopotential sensor data captured at the wrist-wearable device that indicates performance of the selection gesture, causing performance of a third command associated with the third selectable XR interface element.

(C5) In some embodiments of any of C1-C43, the third method 340 further includes, in accordance with the determination that the image data does not satisfy the image quality criterion, causing a second switching indication, indicating that the second biopotential sensor data is being used to detect the selection gesture, to the user.

(C6) In some embodiments of any of C1-C5, the third method 340 further includes, in accordance with a determination that a battery level of the wrist-wearable device is below a battery threshold, present a low-battery indication (e.g., the low-battery notification 370) to a user.

(C7) In some embodiments of any of C1-C6, the third method 340 further includes, in accordance with a determination that the wrist-wearable device does not satisfy a connection criterion and while a fourth focus indicator is over a fourth selectable XR interface element presented by the XR headset: (i) presenting a disconnection indication (e.g., the first switching notification 375), indicating that the image data from the camera of the AR headset is being used to detect the selection gesture, to a user (e.g., the user 101) and (ii), in response to obtaining the image data captured at the XR headset that indicates performance of the selection gesture, causing performance of a fourth command associated with the fourth selectable AR interface element.

(C8) In some embodiments of any of C1-C7, the third method 340 further includes, in accordance with a determination that the wrist-wearable device satisfies the connection criterion and while a fifth focus indicator is over a fifth selectable XR interface element presented by the XR headset: (i) presenting a connection indication (e.g., the second switching notification 380), indicating that the biopotential sensor data captured at the wrist-wearable device is being used to detect the selection gesture, to the user and (ii), in response to obtaining the biopotential sensor data captured at the wrist-wearable device that indicates performance of the selection gesture, causing performance of a fifth command associated with the fifth selectable AR interface element.

(C9) In some embodiments of any of C1-C8, the third method 340 further includes, in accordance with a determination that the wrist-wearable device does not satisfy a connection criterion and a determination that the image data from a camera of the AR headset does not satisfy an image quality threshold, causing a restart indication, requesting the user to restart the AR headset, to be presented to a user.

(C10) In some embodiments of any of C1-C9, the third method 340 further includes, while the first focus indicator is over the first selectable XR interface element presented by the XR headset and in response to obtaining other biopotential sensor data captured at the wrist-wearable device that indicates performance of another selection gesture, causing performance of another command associated with the first selectable XR interface element. The third method 340 further includes, in accordance with the determination that the biopotential sensor data does not satisfy the biopotential quality criterion, while the second focus indicator is over the second selectable XR interface element presented by the XR headset, and in response to obtaining other image data captured at the XR headset that indicates performance of the other selection gesture, causing performance of an additional command associated with the second selectable XR interface element.

(C11) In some embodiments of any of C1-C10, the biopotential sensor data is electromyography (EMG) data captured at an EMG sensor of the wrist-wearable device, and the image data is captured at a camera of the XR headset.

(C12) In some embodiments of any of C1-C11, the XR headset is at least one of a pair of smart glasses and an augmented-reality (AR) headset, and the wrist-wearable device is at least one of a smart-watch and smart wrist-band.

(D1) FIG. 5D illustrates a flow chart of a fourth method 560 for manual user switching from gaze tracking to hand tracking, in accordance with some embodiments.

The fourth method 560 occurs at an XR headset (e.g., the head-wearable device 110) with one or more gaze-tracking devices (e.g., the eye-tracking camera), one or more cameras (e.g., the forward-facing camera), and/or one or more displays (e.g., the display of the head-wearable device 110) worn by a user (e.g., the user 101). In some embodiments, the fourth method 560 occurs while the XR headset is worn by the user. The fourth method 560 includes obtaining gaze data captured at the XR headset (562). The fourth method 560 further includes determining, based on the gaze data, a first point of focus (e.g., the gaze location) within an XR interface (e.g., the UI 150) presented at a display of the XR headset (564). The fourth method 560 further includes, in accordance with a determination that the that the user has performed a switch gesture: (i) ceasing obtaining the gaze data captured at the XR headset, (ii) obtaining image data captured at the XR headset indicating a projected-point position of a hand of the user within the XR interface, and (iii) determining, based on the image data and the projected-point position of the hand of the user, a second point of focus (e.g., the point location) within the XR interface presented at the display of the XR headset.

(D2) In some embodiments of D1, the fourth method 560 further includes, after determining the second point of focus within the XR interface presented at the display of the XR headset and in accordance with a determination that the that the user has performed another switch gesture: (i) ceasing obtaining the image data captured at the XR headset indicating the projected-point position of the hand of the user within the XR interface, (ii) obtaining other gaze data captured at the XR headset, and (iii) determining, based on the other gaze data, a third point of focus within the XR interface presented at the display of the XR headset.

(D3) In some embodiments of any of D1-D2, the fourth method 560 further includes, in accordance with the determination that the that the user has performed the switch gesture, causing the XR headset to present a gaze-to-hand switching indication (e.g., the first switching notification 160, the second switching notification 165, the third switching notification 170, and/or the fourth switching notification 175), indicating that the image data and the projected-point position is being used to determine a point of focus, to the user.

(D4) In some embodiments of any of D1-D3, the fourth method 560 further includes (i) obtaining biopotential sensor data captured at a wrist-wearable device and (ii) determining, based on the biopotential sensor data, whether the user has performed a selection gesture. The fourth method 560 further includes, in accordance with a determination that the that the user has performed a second switch gesture: (i) ceasing obtaining the biopotential sensor data captured at the wrist-wearable device, (ii) obtaining second image data captured at the XR headset, and (iii) determining, based on the second image data, whether the user has performed the selection gesture.

(D5) In some embodiments of any of D1-D4, the fourth method 560 further includes, after determining whether the user has performed the selection gesture and in accordance with a determination that the that the user has performed another second switch gesture, (i) ceasing obtaining the second image data captured at the XR headset, (ii) obtaining additional biopotential sensor data captured at the wrist-wearable device, and (iii) determining, based on the additional biopotential sensor data, whether the user has performed the selection gesture.

(D6) In some embodiments of any of D1-D5, the fourth method 560 further includes, in accordance with the determination that the that the user has performed the second switch gesture, causing the XR headset to present a first switching indication, indicating that the second image data is being used to determine whether the user has performed the selection gesture, to the user.

(D7) In some embodiments of any of D1-D6, the gaze data is captured at an eye-tracking camera of the XR headset, and the image data is captured at a camera of the XR headset.

(D8) In some embodiments of any of D1-D7, the XR headset is at least one of a pair of smart glasses and an augmented-reality (AR) headset.

(E1) FIG. 5E illustrates a flow chart of a fifth method 580 for automatic switching from hand tracking to gaze tracking, in accordance with some embodiments.

The fifth method 560 occurs at an XR headset (e.g., the head-wearable device 110) with one or more gaze-tracking devices (e.g., the eye-tracking camera), one or more cameras (e.g., the forward-facing camera), and/or one or more displays (e.g., the display of the head-wearable device 110) worn by a user (e.g., the user 101). In some embodiments, the fifth method 580 occurs while the XR headset is worn by the user. The fifth method 580 includes (i) obtaining image data from a camera of the XR headset indicating a projected position of a hand of the user within an XR interface (e.g., the UI 150) presented at a display of the XR headset (582) and (ii) determining, based on the image data and the projected position, a third point of focus (e.g., the gaze location) within the XR interface presented by the display of the XR headset (584). The fifth method 580 further includes, in accordance with a determination that the image data does not satisfy an image quality threshold (588): (i) receiving gaze data from the XR headset (590) and (ii) determining, based on the gaze data, a fourth point of focus (e.g., the point location) within an XR interface presented at a display of the XR headset (592). The fifth method 580 further includes causing the XR headset to present a hand-to-gaze switching indication, indicating that the gaze data is being used to determine a point of focus, to the user (596).

(E2) In some embodiments of E1, the method 580 further includes, after determining the first point of focus within the XR interface presented by the display of the XR headset, causing the XR headset to display a hand indicator (e.g., the hand indicator 122) at the first point of focus within the XR interface (586).

(E3) In some embodiments of any of E1-E2, the method 580 further includes, in accordance with the determination that the image data does not satisfy the image-quality threshold, after determining the second point of focus within the XR interface presented by the display of the XR headset, causing the XR headset to display a gaze indicator (e.g., the gaze indicator 124) at the second point of focus within the XR interface (594).

(E4) In some embodiments of any of E1-E3, the hand-to-gaze switching indication includes at least one of a haptic indication presented by a haptic device communicatively coupled to the one or more processors, an audio indication presented by a speaker communicatively coupled to the one or more processors, and a visual indication presented by a display communicatively coupled to the one or more processors.

(E5) In some embodiments of any of E1-E4, the hand-to-gaze switching indication includes one or more selectable options (e.g., the selectable element 172, the first selectable element 177, and/or the second selectable element 179), and obtaining gaze data from the XR headset, determining, based on the gaze data, a second point of focus within an XR interface presented at a display of the XR headset, and causing the XR headset to present a hand-to-gaze switching indication, is further in accordance with a determination that the user selects a first option (e.g. the selectable element 172 and/or the first selectable element 177) of the one or more selectable options.

(E6) In some embodiments of any of E1-E5, the method 580 further includes, in accordance with the determination that the image data does not satisfy the image-quality threshold and a determination that the user selects a second option (e.g., the second selectable element 179) of the one or more selectable options: (i) obtaining other image data from the camera of the XR headset indicating another projected position of the hand of the user within the XR interface presented at the display of the XR headset and (ii) determining, based on the other image data and the other projected position, another point of focus within the XR interface presented by the display of the XR headset

(E7) In some embodiments of any of E1-E6, the method 580 further includes, in accordance with the determination that the gaze data does not satisfy a gaze-quality threshold: (i) obtaining second image data from the camera of the XR headset indicating a second projected position of the hand of the user within the XR interface presented at the display of the XR headset and (ii) determining, based on the second image data and the second projected position, a third point of focus within the XR interface presented by the display of the XR headset.

(E8) In some embodiments of any of E1-E7, the method 580 further includes, in accordance with the determination that the gaze data does not satisfy the gaze-quality threshold: causing the XR headset to present a gaze-to-hand switching indication, indicating that the second image data is being used to determine a point of focus, to the user.

(E9) In some embodiments of any of E1-E8, the method 580 further includes (i) after determining the first point of focus within the XR interface presented by the display of the XR headset, obtaining third image data from the camera of the XR headset indicating a third projected position of the hand of the user within the XR interface presented at the display of the XR headset and (ii) determining, based on the third image data and the third projected position, a fourth point of focus within the XR interface presented by the display of the XR headset.

(E10) In some embodiments of any of E1-E9, the method 580 further includes, in accordance with the determination that the image data does not satisfy the image-quality threshold: (i) obtaining second gaze data captured at the XR headset and (ii) determining, based on the second gaze data, a fifth point of focus within the XR interface presented by the display of the XR headset.

(E11) In some embodiments of any of E1-E10, the method 580 further includes, before obtaining the image data captured at the XR headset indicating the projected-point position of the hand of the user within the XR interface and in accordance with a determination that the XR headset is not configured to detect the image data from the user: (i) causing the XR headset to present a hand tutorial request (e.g., the hand tracking tutorial notification 210) to the user and (ii) in accordance with a determination that the user accepts the hand tutorial request, causing the XR headset to present a hand-detection tutorial to the user (e.g., as described in reference to FIG. 2B).

(E12) In some embodiments of any of E1-E11, the method 580 further includes, in accordance with the determination that the image data does not satisfy the image-quality threshold and before obtaining the gaze data captured at the XR headset and in accordance with a determination that the XR headset is not configured to detect the gaze data from the user: (i) causing the XR headset to present a gaze configuration request (e.g., the gaze tracking tutorial notification 230) to the user and (ii) in accordance with a determination that the user accepts the gaze configuration request, causing the XR headset to be configured to detect the gaze data from the user (e.g., as described in reference to FIG. 2D).

(E13) In some embodiments of any of E1-E12, the method 580 further includes, in accordance with the determination that the image data does not satisfy the image-quality threshold, in accordance with a determination that the gaze data does not satisfy a gaze-quality threshold, cause the XR headset to present a restart indication, requesting the user to restart the AR headset, to the user.

(E14) In some embodiments of any of E1-E13, the method 580 further includes, after determining the first point of focus within the XR interface presented by the display of the XR headset: (i) obtaining hand gesture data and (ii) determining an instruction based on the hand gesture data and the first point of focus. The method 580 further includes, in accordance with the determination that the image data does not satisfy the image-quality threshold and after determining the second point of focus within the XR interface presented by the display of the XR headset: (i) obtaining other hand gesture data and (ii) determining another instruction based on the other hand gesture data and the second point of focus.

(E15) In some embodiments of any of E1-E14, the gaze data is captured at an eye-tracking camera of the XR headset and the image data is captured at a camera of the XR headset.

(E16) In some embodiments of any of E1-E15, the XR headset is at least one of a pair of smart glasses, smart contacts, and an augmented-reality (AR) headset.

(F1) In accordance with some embodiments, a system that includes one or more wrist wearable devices and a pair of augmented-reality glasses, and the system is configured to perform operations corresponding to any of A1-E16.

(G1) In accordance with some embodiments, a head-wearable device configured to perform operations corresponding to any of A1-E16.

(H1) In accordance with some embodiments, a method of operating a pair of augmented-reality glasses, including operations that correspond to any of A1-E16.

### Example Extended-Reality Systems

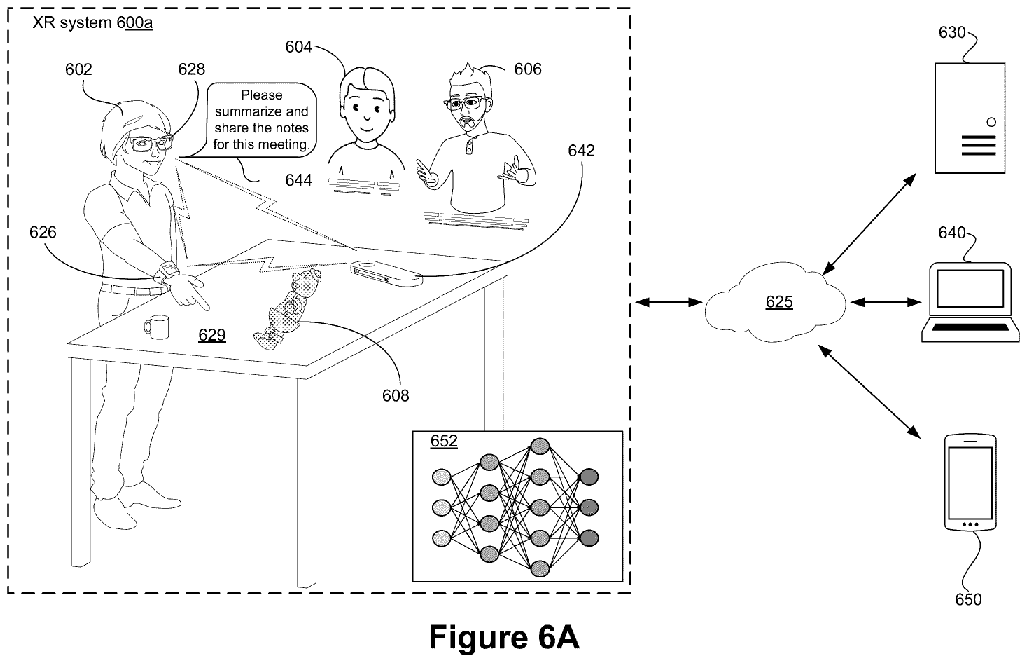

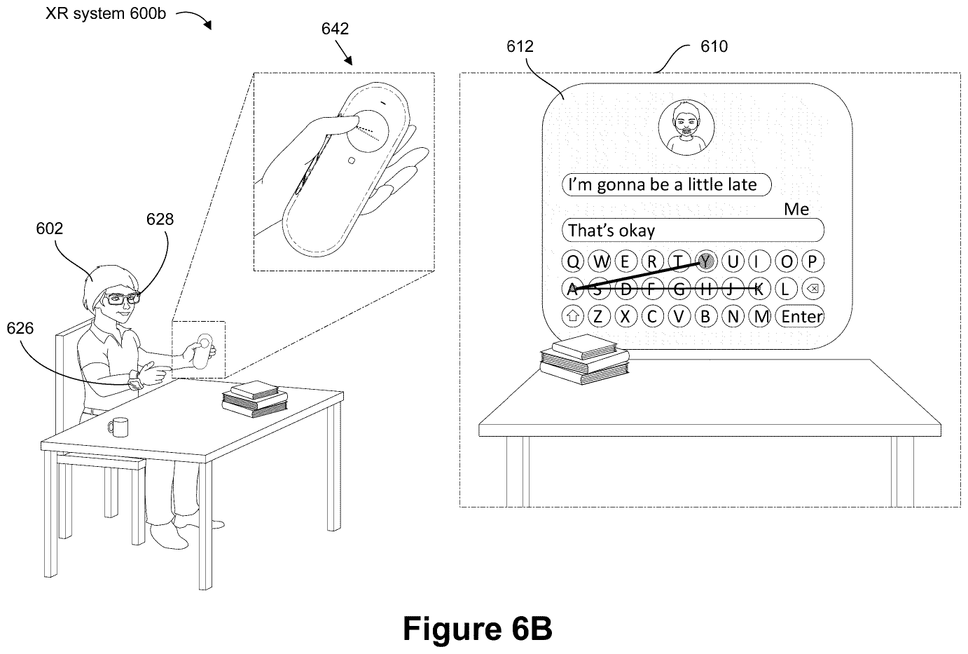

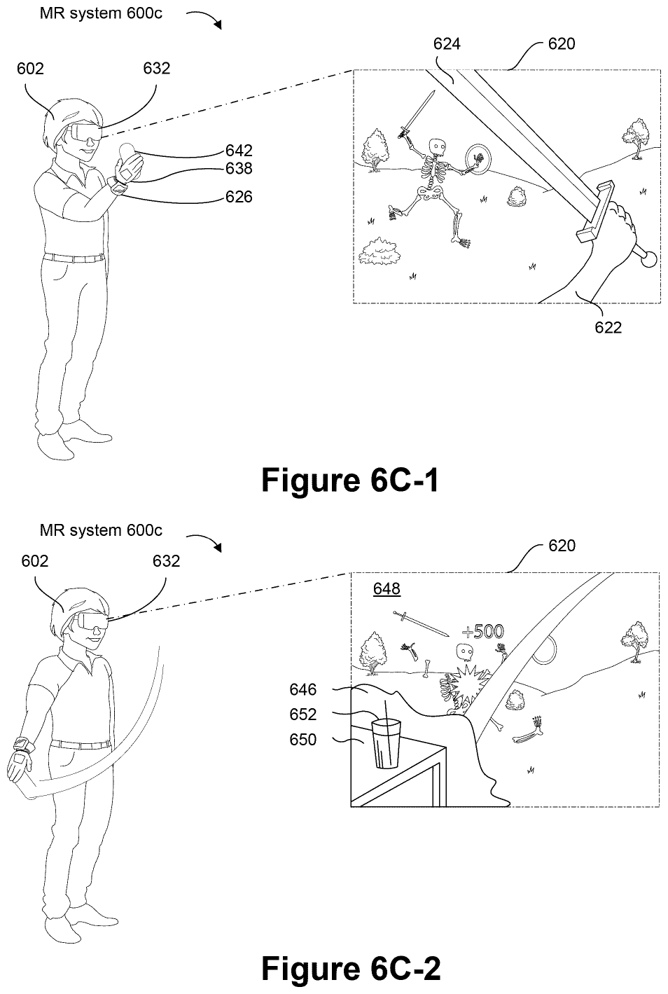

FIGS. 6A 6B, 6C-1, and 6C-2, illustrate example XR systems that include AR and MR systems, in accordance with some embodiments. FIG. 6A shows a first XR system 600a and first example user interactions using a wrist-wearable device 626, a head-wearable device (e.g., AR device 628), and/or a HIPD 642. FIG. 6B shows a second XR system 600b and second example user interactions using a wrist-wearable device 626, AR device 628, and/or an HIPD 642. FIGS. 6C-1 and 6C-2 show a third MR system 600c and third example user interactions using a wrist-wearable device 626, a head-wearable device (e.g., an MR device such as a VR device), and/or an HIPD 642. As the skilled artisan will appreciate upon reading the descriptions provided herein, the above-example AR and MR systems (described in detail below) can perform various functions and/or operations.

The wrist-wearable device 626, the head-wearable devices, and/or the HIPD 642 can communicatively couple via a network 625 (e.g., cellular, near field, Wi-Fi, personal area network, wireless LAN). Additionally, the wrist-wearable device 626, the head-wearable device, and/or the HIPD 642 can also communicatively couple with one or more servers 630, computers 640 (e.g., laptops, computers), mobile devices 650 (e.g., smartphones, tablets), and/or other electronic devices via the network 625 (e.g., cellular, near field, Wi-Fi, personal area network, wireless LAN). Similarly, a smart textile-based garment, when used, can also communicatively couple with the wrist-wearable device 626, the head-wearable device(s), the HIPD 642, the one or more servers 630, the computers 640, the mobile devices 650, and/or other electronic devices via the network 625 to provide inputs.

Turning to FIG. 6A, a user 602 is shown wearing the wrist-wearable device 626 and the AR device 628 and having the HIPD 642 on their desk. The wrist-wearable device 626, the AR device 628, and the HIPD 642 facilitate user interaction with an AR environment. In particular, as shown by the first AR system 600a, the wrist-wearable device 626, the AR device 628, and/or the HIPD 642 cause presentation of one or more avatars 604, digital representations of contacts 606, and virtual objects 608. As discussed below, the user 602 can interact with the one or more avatars 604, digital representations of the contacts 606, and virtual objects 608 via the wrist-wearable device 626, the AR device 628, and/or the HIPD 642. In addition, the user 602 is also able to directly view physical objects in the environment, such as a physical table 629, through transparent lens(es) and waveguide(s) of the AR device 628. Alternatively, an MR device could be used in place of the AR device 628 and a similar user experience can take place, but the user would not be directly viewing physical objects in the environment, such as table 629, and would instead be presented with a virtual reconstruction of the table 629 produced from one or more sensors of the MR device (e.g., an outward facing camera capable of recording the surrounding environment).

The user 602 can use any of the wrist-wearable device 626, the AR device 628 (e.g., through physical inputs at the AR device and/or built-in motion tracking of a user's extremities), a smart-textile garment, externally mounted extremity tracking device, the HIPD 642 to provide user inputs, etc. For example, the user 602 can perform one or more hand gestures that are detected by the wrist-wearable device 626 (e.g., using one or more EMG sensors and/or IMUs built into the wrist-wearable device) and/or AR device 628 (e.g., using one or more image sensors or cameras) to provide a user input. Alternatively, or additionally, the user 602 can provide a user input via one or more touch surfaces of the wrist-wearable device 626, the AR device 628, and/or the HIPD 642, and/or voice commands captured by a microphone of the wrist-wearable device 626, the AR device 628, and/or the HIPD 642. The wrist-wearable device 626, the AR device 628, and/or the HIPD 642 include an artificially intelligent digital assistant to help the user in providing a user input (e.g., completing a sequence of operations, suggesting different operations or commands, providing reminders, confirming a command). For example, the digital assistant can be invoked through an input occurring at the AR device 628 (e.g., via an input at a temple arm of the AR device 628). In some embodiments, the user 602 can provide a user input via one or more facial gestures and/or facial expressions. For example, cameras of the wrist-wearable device 626, the AR device 628, and/or the HIPD 642 can track the user 602's eyes for navigating a user interface.

The wrist-wearable device 626, the AR device 628, and/or the HIPD 642 can operate alone or in conjunction to allow the user 602 to interact with the AR environment. In some embodiments, the HIPD 642 is configured to operate as a central hub or control center for the wrist-wearable device 626, the AR device 628, and/or another communicatively coupled device. For example, the user 602 can provide an input to interact with the AR environment at any of the wrist-wearable device 626, the AR device 628, and/or the HIPD 642, and the HIPD 642 can identify one or more back-end and front-end tasks to cause the performance of the requested interaction and distribute instructions to cause the performance of the one or more back-end and front-end tasks at the wrist-wearable device 626, the AR device 628, and/or the HIPD 642. In some embodiments, a back-end task is a background-processing task that is not perceptible by the user (e.g., rendering content, decompression, compression, application-specific operations), and a front-end task is a user-facing task that is perceptible to the user (e.g., presenting information to the user, providing feedback to the user). The HIPD 642 can perform the back-end tasks and provide the wrist-wearable device 626 and/or the AR device 628 operational data corresponding to the performed back-end tasks such that the wrist-wearable device 626 and/or the AR device 628 can perform the front-end tasks. In this way, the HIPD 642, which has more computational resources and greater thermal headroom than the wrist-wearable device 626 and/or the AR device 628, performs computationally intensive tasks and reduces the computer resource utilization and/or power usage of the wrist-wearable device 626 and/or the AR device 628.

In the example shown by the first AR system 600a, the HIPD 642 identifies one or more back-end tasks and front-end tasks associated with a user request to initiate an AR video call with one or more other users (represented by the avatar 604 and the digital representation of the contact 606) and distributes instructions to cause the performance of the one or more back-end tasks and front-end tasks. In particular, the HIPD 642 performs back-end tasks for processing and/or rendering image data (and other data) associated with the AR video call and provides operational data associated with the performed back-end tasks to the AR device 628 such that the AR device 628 performs front-end tasks for presenting the AR video call (e.g., presenting the avatar 604 and the digital representation of the contact 606).

In some embodiments, the HIPD 642 can operate as a focal or anchor point for causing the presentation of information. This allows the user 602 to be generally aware of where information is presented. For example, as shown in the first AR system 600a, the avatar 604 and the digital representation of the contact 606 are presented above the HIPD 642. In particular, the HIPD 642 and the AR device 628 operate in conjunction to determine a location for presenting the avatar 604 and the digital representation of the contact 606. In some embodiments, information can be presented within a predetermined distance from the HIPD 642 (e.g., within five meters). For example, as shown in the first AR system 600a, virtual object 608 is presented on the desk some distance from the HIPD 642. Similar to the above example, the HIPD 642 and the AR device 628 can operate in conjunction to determine a location for presenting the virtual object 608. Alternatively, in some embodiments, presentation of information is not bound by the HIPD 642. More specifically, the avatar 604, the digital representation of the contact 606, and the virtual object 608 do not have to be presented within a predetermined distance of the HIPD 642. While an AR device 628 is described working with an HIPD, an MR headset can be interacted with in the same way as the AR device 628.

User inputs provided at the wrist-wearable device 626, the AR device 628, and/or the HIPD 642 are coordinated such that the user can use any device to initiate, continue, and/or complete an operation. For example, the user 602 can provide a user input to the AR device 628 to cause the AR device 628 to present the virtual object 608 and, while the virtual object 608 is presented by the AR device 628, the user 602 can provide one or more hand gestures via the wrist-wearable device 626 to interact and/or manipulate the virtual object 608. While an AR device 628 is described working with a wrist-wearable device 626, an MR headset can be interacted with in the same way as the AR device 628.

Integration of Artificial Intelligence with XR Systems

FIG. 6A illustrates an interaction in which an artificially intelligent virtual assistant can assist in requests made by a user 602. The AI virtual assistant can be used to complete open-ended requests made through natural language inputs by a user 602. For example, in FIG. 6A the user 602 makes an audible request 644 to summarize the conversation and then share the summarized conversation with others in the meeting. In addition, the AI virtual assistant is configured to use sensors of the XR system (e.g., cameras of an XR headset, microphones, and various other sensors of any of the devices in the system) to provide contextual prompts to the user for initiating tasks.

FIG. 6A also illustrates an example neural network 652 used in Artificial Intelligence applications. Uses of Artificial Intelligence (AI) are varied and encompass many different aspects of the devices and systems described herein. AI capabilities cover a diverse range of applications and deepen interactions between the user 602 and user devices (e.g., the AR device 628, an MR device 632, the HIPD 642, the wrist-wearable device 626). The AI discussed herein can be derived using many different training techniques. While the primary AI model example discussed herein is a neural network, other AI models can be used. Non-limiting examples of AI models include artificial neural networks (ANNs), deep neural networks (DNNs), convolution neural networks (CNNs), recurrent neural networks (RNNs), large language models (LLMs), long short-term memory networks, transformer models, decision trees, random forests, support vector machines, k-nearest neighbors, genetic algorithms, Markov models, Bayesian networks, fuzzy logic systems, and deep reinforcement learnings, etc. The AI models can be implemented at one or more of the user devices, and/or any other devices described herein. For devices and systems herein that employ multiple AI models, different models can be used depending on the task. For example, for a natural-language artificially intelligent virtual assistant, an LLM can be used and for the object detection of a physical environment, a DNN can be used instead.

In another example, an AI virtual assistant can include many different AI models and based on the user's request, multiple AI models may be employed (concurrently, sequentially or a combination thereof). For example, an LLM-based AI model can provide instructions for helping a user follow a recipe and the instructions can be based in part on another AI model that is derived from an ANN, a DNN, an RNN, etc. that is capable of discerning what part of the recipe the user is on (e.g., object and scene detection).

As AI training models evolve, the operations and experiences described herein could potentially be performed with different models other than those listed above, and a person skilled in the art would understand that the list above is non-limiting.

A user 602 can interact with an AI model through natural language inputs captured by a voice sensor, text inputs, or any other input modality that accepts natural language and/or a corresponding voice sensor module. In another instance, input is provided by tracking the eye gaze of a user 602 via a gaze tracker module. Additionally, the AI model can also receive inputs beyond those supplied by a user 602. For example, the AI can generate its response further based on environmental inputs (e.g., temperature data, image data, video data, ambient light data, audio data, GPS location data, inertial measurement (i.e., user motion) data, pattern recognition data, magnetometer data, depth data, pressure data, force data, neuromuscular data, heart rate data, temperature data, sleep data) captured in response to a user request by various types of sensors and/or their corresponding sensor modules. The sensors' data can be retrieved entirely from a single device (e.g., AR device 628) or from multiple devices that are in communication with each other (e.g., a system that includes at least two of an AR device 628, an MR device 632, the HIPD 642, the wrist-wearable device 626, etc.). The AI model can also access additional information (e.g., one or more servers 630, the computers 640, the mobile devices 650, and/or other electronic devices) via a network 625.

A non-limiting list of AI-enhanced functions includes but is not limited to image recognition, speech recognition (e.g., automatic speech recognition), text recognition (e.g., scene text recognition), pattern recognition, natural language processing and understanding, classification, regression, clustering, anomaly detection, sequence generation, content generation, and optimization. In some embodiments, AI-enhanced functions are fully or partially executed on cloud-computing platforms communicatively coupled to the user devices (e.g., the AR device 628, an MR device 632, the HIPD 642, the wrist-wearable device 626) via the one or more networks. The cloud-computing platforms provide scalable computing resources, distributed computing, managed AI services, interference acceleration, pre-trained models, APIs and/or other resources to support comprehensive computations required by the AI-enhanced function.

Example outputs stemming from the use of an AI model can include natural language responses, mathematical calculations, charts displaying information, audio, images, videos, texts, summaries of meetings, predictive operations based on environmental factors, classifications, pattern recognitions, recommendations, assessments, or other operations. In some embodiments, the generated outputs are stored on local memories of the user devices (e.g., the AR device 628, an MR device 632, the HIPD 642, the wrist-wearable device 626), storage options of the external devices (servers, computers, mobile devices, etc.), and/or storage options of the cloud-computing platforms.

The AI-based outputs can be presented across different modalities (e.g., audio-based, visual-based, haptic-based, and any combination thereof) and across different devices of the XR system described herein. Some visual-based outputs can include the displaying of information on XR augments of an XR headset, user interfaces displayed at a wrist-wearable device, laptop device, mobile device, etc. On devices with or without displays (e.g., HIPD 642), haptic feedback can provide information to the user 602. An AI model can also use the inputs described above to determine the appropriate modality and device(s) to present content to the user (e.g., a user walking on a busy road can be presented with an audio output instead of a visual output to avoid distracting the user 602).

### Example Augmented Reality Interaction

FIG. 6B shows the user 602 wearing the wrist-wearable device 626 and the AR device 628 and holding the HIPD 642. In the second AR system 600b, the wrist-wearable device 626, the AR device 628, and/or the HIPD 642 are used to receive and/or provide one or more messages to a contact of the user 602. In particular, the wrist-wearable device 626, the AR device 628, and/or the HIPD 642 detect and coordinate one or more user inputs to initiate a messaging application and prepare a response to a received message via the messaging application.

In some embodiments, the user 602 initiates, via a user input, an application on the wrist-wearable device 626, the AR device 628, and/or the HIPD 642 that causes the application to initiate on at least one device. For example, in the second AR system 600b the user 602 performs a hand gesture associated with a command for initiating a messaging application (represented by messaging user interface 612); the wrist-wearable device 626 detects the hand gesture; and, based on a determination that the user 602 is wearing the AR device 628, causes the AR device 628 to present a messaging user interface 612 of the messaging application. The AR device 628 can present the messaging user interface 612 to the user 602 via its display (e.g., as shown by user 602's field of view 610). In some embodiments, the application is initiated and can be run on the device (e.g., the wrist-wearable device 626, the AR device 628, and/or the HIPD 642) that detects the user input to initiate the application, and the device provides another device operational data to cause the presentation of the messaging application. For example, the wrist-wearable device 626 can detect the user input to initiate a messaging application, initiate and run the messaging application, and provide operational data to the AR device 628 and/or the HIPD 642 to cause presentation of the messaging application. Alternatively, the application can be initiated and run at a device other than the device that detected the user input. For example, the wrist-wearable device 626 can detect the hand gesture associated with initiating the messaging application and cause the HIPD 642 to run the messaging application and coordinate the presentation of the messaging application.

Further, the user 602 can provide a user input provided at the wrist-wearable device 626, the AR device 628, and/or the HIPD 642 to continue and/or complete an operation initiated at another device. For example, after initiating the messaging application via the wrist-wearable device 626 and while the AR device 628 presents the messaging user interface 612, the user 602 can provide an input at the HIPD 642 to prepare a response (e.g., shown by the swipe gesture performed on the HIPD 642). The user 602's gestures performed on the HIPD 642 can be provided and/or displayed on another device. For example, the user 602's swipe gestures performed on the HIPD 642 are displayed on a virtual keyboard of the messaging user interface 612 displayed by the AR device 628.

In some embodiments, the wrist-wearable device 626, the AR device 628, the HIPD 642, and/or other communicatively coupled devices can present one or more notifications to the user 602. The notification can be an indication of a new message, an incoming call, an application update, a status update, etc. The user 602 can select the notification via the wrist-wearable device 626, the AR device 628, or the HIPD 642 and cause presentation of an application or operation associated with the notification on at least one device. For example, the user 602 can receive a notification that a message was received at the wrist-wearable device 626, the AR device 628, the HIPD 642, and/or other communicatively coupled device and provide a user input at the wrist-wearable device 626, the AR device 628, and/or the HIPD 642 to review the notification, and the device detecting the user input can cause an application associated with the notification to be initiated and/or presented at the wrist-wearable device 626, the AR device 628, and/or the HIPD 642.

While the above example describes coordinated inputs used to interact with a messaging application, the skilled artisan will appreciate upon reading the descriptions that user inputs can be coordinated to interact with any number of applications including, but not limited to, gaming applications, social media applications, camera applications, web-based applications, financial applications, etc. For example, the AR device 628 can present to the user 602 game application data and the HIPD 642 can use a controller to provide inputs to the game. Similarly, the user 602 can use the wrist-wearable device 626 to initiate a camera of the AR device 628, and the user can use the wrist-wearable device 626, the AR device 628, and/or the HIPD 642 to manipulate the image capture (e.g., zoom in or out, apply filters) and capture image data.

While an AR device 628 is shown being capable of certain functions, it is understood that an AR device can be an AR device with varying functionalities based on costs and market demands. For example, an AR device may include a single output modality such as an audio output modality. In another example, the AR device may include a low-fidelity display as one of the output modalities, where simple information (e.g., text and/or low-fidelity images/video) is capable of being presented to the user. In yet another example, the AR device can be configured with face-facing light emitting diodes (LEDs) configured to provide a user with information, e.g., an LED around the right-side lens can illuminate to notify the wearer to turn right while directions are being provided or an LED on the left-side can illuminate to notify the wearer to turn left while directions are being provided. In another embodiment, the AR device can include an outward-facing projector such that information (e.g., text information, media) may be displayed on the palm of a user's hand or other suitable surface (e.g., a table, whiteboard). In yet another embodiment, information may also be provided by locally dimming portions of a lens to emphasize portions of the environment in which the user's attention should be directed. Some AR devices can present AR augments either monocularly or binocularly (e.g., an AR augment can be presented at only a single display associated with a single lens as opposed presenting an AR augmented at both lenses to produce a binocular image). In some instances an AR device capable of presenting AR augments binocularly can optionally display AR augments monocularly as well (e.g., for power-saving purposes or other presentation considerations). These examples are non-exhaustive and features of one AR device described above can be combined with features of another AR device described above. While features and experiences of an AR device have been described generally in the preceding sections, it is understood that the described functionalities and experiences can be applied in a similar manner to an MR headset, which is described below in the proceeding sections.

### Example Mixed Reality Interaction

Turning to FIGS. 6C-1 and 6C-2, the user 602 is shown wearing the wrist-wearable device 626 and an MR device 632 (e.g., a device capable of providing either an entirely VR experience or an MR experience that displays object(s) from a physical environment at a display of the device) and holding the HIPD 642. In the third AR system 600c, the wrist-wearable device 626, the MR device 632, and/or the HIPD 642 are used to interact within an MR environment, such as a VR game or other MR/VR application. While the MR device 632 presents a representation of a VR game (e.g., first MR game environment 620) to the user 602, the wrist-wearable device 626, the MR device 632, and/or the HIPD 642 detect and coordinate one or more user inputs to allow the user 602 to interact with the VR game.

In some embodiments, the user 602 can provide a user input via the wrist-wearable device 626, the MR device 632, and/or the HIPD 642 that causes an action in a corresponding MR environment. For example, the user 602 in the third MR system 600c (shown in FIG. 6C-1) raises the HIPD 642 to prepare for a swing in the first MR game environment 620. The MR device 632, responsive to the user 602 raising the HIPD 642, causes the MR representation of the user 622 to perform a similar action (e.g., raise a virtual object, such as a virtual sword 624). In some embodiments, each device uses respective sensor data and/or image data to detect the user input and provide an accurate representation of the user 602's motion. For example, image sensors (e.g., SLAM cameras or other cameras) of the HIPD 642 can be used to detect a position of the HIPD 642 relative to the user 602's body such that the virtual object can be positioned appropriately within the first MR game environment 620; sensor data from the wrist-wearable device 626 can be used to detect a velocity at which the user 602 raises the HIPD 642 such that the MR representation of the user 622 and the virtual sword 624 are synchronized with the user 602's movements; and image sensors of the MR device 632 can be used to represent the user 602's body, boundary conditions, or real-world objects within the first MR game environment 620.

In FIG. 6C-2, the user 602 performs a downward swing while holding the HIPD 642. The user 602's downward swing is detected by the wrist-wearable device 626, the MR device 632, and/or the HIPD 642 and a corresponding action is performed in the first MR game environment 620. In some embodiments, the data captured by each device is used to improve the user's experience within the MR environment. For example, sensor data of the wrist-wearable device 626 can be used to determine a speed and/or force at which the downward swing is performed and image sensors of the HIPD 642 and/or the MR device 632 can be used to determine a location of the swing and how it should be represented in the first MR game environment 620, which, in turn, can be used as inputs for the MR environment (e.g., game mechanics, which can use detected speed, force, locations, and/or aspects of the user 602's actions to classify a user's inputs (e.g., user performs a light strike, hard strike, critical strike, glancing strike, miss) or calculate an output (e.g., amount of damage)).

FIG. 6C-2 further illustrates that a portion of the physical environment is reconstructed and displayed at a display of the MR device 632 while the MR game environment 620 is being displayed. In this instance, a reconstruction of the physical environment 646 is displayed in place of a portion of the MR game environment 620 when object(s) in the physical environment are potentially in the path of the user (e.g., a collision with the user and an object in the physical environment are likely). Thus, this example MR game environment 620 includes (i) an immersive VR portion 648 (e.g., an environment that does not have a corollary counterpart in a nearby physical environment) and (ii) a reconstruction of the physical environment 646 (e.g., table 650 and cup 652). While the example shown here is an MR environment that shows a reconstruction of the physical environment to avoid collisions, other uses of reconstructions of the physical environment can be used, such as defining features of the virtual environment based on the surrounding physical environment (e.g., a virtual column can be placed based on an object in the surrounding physical environment (e.g., a tree)).

While the wrist-wearable device 626, the MR device 632, and/or the HIPD 642 are described as detecting user inputs, in some embodiments, user inputs are detected at a single device (with the single device being responsible for distributing signals to the other devices for performing the user input). For example, the HIPD 642 can operate an application for generating the first MR game environment 620 and provide the MR device 632 with corresponding data for causing the presentation of the first MR game environment 620, as well as detect the user 602's movements (while holding the HIPD 642) to cause the performance of corresponding actions within the first MR game environment 620. Additionally or alternatively, in some embodiments, operational data (e.g., sensor data, image data, application data, device data, and/or other data) of one or more devices is provided to a single device (e.g., the HIPD 642) to process the operational data and cause respective devices to perform an action associated with processed operational data.

In some embodiments, the user 602 can wear a wrist-wearable device 626, wear an MR device 632, wear smart textile-based garments 638 (e.g., wearable haptic gloves), and/or hold an HIPD 642 device. In this embodiment, the wrist-wearable device 626, the MR device 632, and/or the smart textile-based garments 638 are used to interact within an MR environment (e.g., any AR or MR system described above in reference to FIGS. 6A-6B). While the MR device 632 presents a representation of an MR game (e.g., second MR game environment 620) to the user 602, the wrist-wearable device 626, the MR device 632, and/or the smart textile-based garments 638 detect and coordinate one or more user inputs to allow the user 602 to interact with the MR environment.

In some embodiments, the user 602 can provide a user input via the wrist-wearable device 626, an HIPD 642, the MR device 632, and/or the smart textile-based garments 638 that causes an action in a corresponding MR environment. In some embodiments, each device uses respective sensor data and/or image data to detect the user input and provide an accurate representation of the user 602's motion. While four different input devices are shown (e.g., a wrist-wearable device 626, an MR device 632, an HIPD 642, and a smart textile-based garment 638) each one of these input devices entirely on its own can provide inputs for fully interacting with the MR environment. For example, the wrist-wearable device can provide sufficient inputs on its own for interacting with the MR environment. In some embodiments, if multiple input devices are used (e.g., a wrist-wearable device and the smart textile-based garment 638) sensor fusion can be utilized to ensure inputs are correct. While multiple input devices are described, it is understood that other input devices can be used in conjunction or on their own instead, such as but not limited to external motion-tracking cameras, other wearable devices fitted to different parts of a user, apparatuses that allow for a user to experience walking in an MR environment while remaining substantially stationary in the physical environment, etc.

As described above, the data captured by each device is used to improve the user's experience within the MR environment. Although not shown, the smart textile-based garments 638 can be used in conjunction with an MR device and/or an HIPD 642.

While some experiences are described as occurring on an AR device and other experiences are described as occurring on an MR device, one skilled in the art would appreciate that experiences can be ported over from an MR device to an AR device, and vice versa.

Some definitions of devices and components that can be included in some or all of the example devices discussed are defined here for ease of reference. A skilled artisan will appreciate that certain types of the components described may be more suitable for a particular set of devices, and less suitable for a different set of devices. But subsequent reference to the components defined here should be considered to be encompassed by the definitions provided.

In some embodiments example devices and systems, including electronic devices and systems, will be discussed. Such example devices and systems are not intended to be limiting, and one of skill in the art will understand that alternative devices and systems to the example devices and systems described herein may be used to perform the operations and construct the systems and devices that are described herein.

As described herein, an electronic device is a device that uses electrical energy to perform a specific function. It can be any physical object that contains electronic components such as transistors, resistors, capacitors, diodes, and integrated circuits. Examples of electronic devices include smartphones, laptops, digital cameras, televisions, gaming consoles, and music players, as well as the example electronic devices discussed herein. As described herein, an intermediary electronic device is a device that sits between two other electronic devices, and/or a subset of components of one or more electronic devices and facilitates communication, and/or data processing and/or data transfer between the respective electronic devices and/or electronic components.

The foregoing descriptions of FIGS. 6A-6C-2 provided above are intended to augment the description provided in reference to FIGS. 1A-5D. While terms in the following description may not be identical to terms used in the foregoing description, a person having ordinary skill in the art would understand these terms to have the same meaning.

Any data collection performed by the devices described herein and/or any devices configured to perform or cause the performance of the different embodiments described above in reference to any of the Figures, hereinafter the “devices,” is done with user consent and in a manner that is consistent with all applicable privacy laws. Users are given options to allow the devices to collect data, as well as the option to limit or deny collection of data by the devices. A user is able to opt in or opt out of any data collection at any time. Further, users are given the option to request the removal of any collected data.

It will be understood that, although the terms “first,” “second,” etc. may be used herein to describe various elements, these elements should not be limited by these terms. These terms are only used to distinguish one element from another.

The terminology used herein is for the purpose of describing particular embodiments only and is not intended to be limiting of the claims. As used in the description of the embodiments and the appended claims, the singular forms “a,” “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” can be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” can be construed to mean “upon determining” or “in response to determining” or “in accordance with a determination” or “upon detecting” or “in response to detecting” that the stated condition precedent is true, depending on the context.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

What is claimed is:

1. A non-transitory, computer-readable storage medium including executable instructions that, when executed by one or more processors, cause the one or more processors to:
while an extended-reality (XR) headset is worn by a user:
obtain gaze data captured at the XR headset;
determine, based on the gaze data, a first point of focus within an XR interface presented at a display of the XR headset; and
in accordance with a determination that the gaze data does not satisfy a gaze-quality threshold:
obtain image data captured at the XR headset indicating a projected-point position of a hand of the user within the XR interface;
determine, based on the image data and the projected-point position, a second point of focus within the XR interface presented by the display of the XR headset; and
cause the XR headset to present a gaze-to-hand switching indication, indicating that the image data and the projected-point position is being used to determine a point of focus, to the user.

2. The non-transitory, computer-readable storage medium of claim 1, wherein the executable instructions further cause the one or more processors to:
while the XR headset is worn by the user:
after determining the first point of focus within the XR interface presented by the display of the XR headset, cause the XR headset to display a gaze indicator at the first point of focus within the XR interface.

3. The non-transitory, computer-readable storage medium of claim 1, wherein the executable instructions further cause the one or more processors to:
while the XR headset is worn by the user:
in accordance with the determination that the gaze data does not satisfy the gaze-quality threshold:
after determining the second point of focus within the XR interface presented by the display of the XR headset, cause the XR headset to display a hand indicator at the second point of focus within the XR interface.

4. The non-transitory, computer-readable storage medium of claim 1, wherein the gaze-to-hand switching indication includes at least one of a haptic indication presented by a haptic device communicatively coupled to the one or more processors, an audio indication presented by a speaker communicatively coupled to the one or more processors, and a visual indication presented by a display communicatively coupled to the one or more processors.

5. The non-transitory, computer-readable storage medium of claim 1, wherein:
the gaze-to-hand switching indication includes one or more selectable options; and
obtaining the image data from the camera of the XR headset indicating the projected-point position of the hand of the user within the XR interface, determining, based on the image data and the projected-point position, the first point of focus within the XR interface presented by the display of the XR headset, and causing the XR headset to present a gaze-to-hand switching indication, is further in accordance with a determination that the user selects a first option of the one or more selectable options.

6. The non-transitory, computer-readable storage medium of claim 5, wherein the executable instructions further cause the one or more processors to:
while the XR headset is worn by the user:
in accordance with the determination that the gaze data does not satisfy the gaze-quality threshold and a determination that the user selects a second option of the one or more selectable options:
obtain other gaze data from the XR headset; and
determine, based on the other gaze data, another point of focus within the XR interface presented by the display of the XR headset.

7. The non-transitory, computer-readable storage medium of claim 1, wherein the executable instructions further cause the one or more processors to:
while the XR headset is worn by the user:
in accordance with a determination that the image data does not satisfy an image-quality threshold:
obtain second gaze data captured at the XR headset; and
determine, based on the second gaze data, a third point of focus within the XR interface presented by the display of the XR headset.

8. The non-transitory, computer-readable storage medium of claim 7, wherein the executable instructions further cause the one or more processors to:
while the XR headset is worn by the user:
in accordance with the determination that the image data does not satisfy the image-quality threshold:
cause the XR headset to present a hand-to-gaze switching indication, indicating that the second gaze data is being used to determine a point of focus, to the user.

9. The non-transitory, computer-readable storage medium of any of claim 1, wherein the executable instructions further cause the one or more processors to:
while the XR headset is worn by the user:
after determining the first point of focus within the XR interface presented by the display of the XR headset, obtain third gaze data captured at the XR headset;
determine, based on the third gaze data, a fourth point of focus within the XR interface presented by the display of the XR headset.

10. The non-transitory, computer-readable storage medium of claim 9, wherein the executable instructions further cause the one or more processors to:
while the XR headset is worn by the user:
in accordance with the determination that the gaze data does not satisfy the gaze-quality threshold:
after determining the second point of focus within the XR interface presented by the display of the XR headset, obtain second image data captured at the XR headset indicating a second projected position of the hand of the user within the XR interface; and
determine, based on the second image data and the second projected position, a fifth point of focus within the XR interface presented by the display of the XR headset.

11. The non-transitory, computer-readable storage medium of claim 1, wherein the executable instructions further cause the one or more processors to:
while the XR headset is worn by the user:
before obtaining the gaze data captured at the XR headset and in accordance with a determination that the XR headset is not configured to detect the gaze data from the user:
cause the XR headset to present a gaze configuration request to the user; and
in accordance with a determination that the user accepts the gaze configuration request, cause the XR headset to be configured to detect the gaze data from the user.

12. The non-transitory, computer-readable storage medium of claim 1, wherein the executable instructions further cause the one or more processors to:
while the XR headset is worn by the user:
in accordance with the determination that the gaze data does not satisfy the gaze-quality threshold:
before obtaining the image data captured at the XR headset indicating the projected-point position of the hand of the user within the XR interface and in accordance with a determination that the XR headset is not configured to detect the image data from the user:
cause the XR headset to present a hand tutorial request to the user; and
in accordance with a determination that the user accepts the hand tutorial request, cause the XR headset to present a hand-detection tutorial to the user.

13. The non-transitory, computer-readable storage medium of claim 1, wherein the executable instructions further cause the one or more processors to:
while the XR headset is worn by the user:
in accordance with the determination that the gaze data does not satisfy the gaze-quality threshold:
in accordance with a determination that the image data does not satisfy an image-quality threshold, cause the XR headset to present a restart indication, requesting the user to restart the AR headset, to the user.

14. The non-transitory, computer-readable storage medium of claim 1, wherein the executable instructions further cause the one or more processors to:
while the XR headset is worn by the user:
after determining the first point of focus within the XR interface presented by the display of the XR headset:
obtain hand gesture data;
determine an instruction based on the hand gesture data and the first point of focus; and
in accordance with the determination that the gaze data does not satisfy the gaze-quality threshold and after determining the second point of focus within the XR interface presented by the display of the XR headset:
obtain other hand gesture data; and
determine another instruction based on the other hand gesture data and the second point of focus.

15. The non-transitory, computer-readable storage medium of claim 1, wherein:
the gaze data is captured at an eye-tracking camera of the XR headset; and
the image data is captured at a camera of the XR headset.

16. The non-transitory, computer-readable storage medium of claim 1, wherein the XR headset is at least one of a pair of smart glasses, smart contacts, and an augmented-reality (AR) headset.

17. A method, the method comprising:
while an extended-reality (XR) headset is worn by a user:
capturing gaze data at the XR headset;
determining, based on the gaze data, a first point of focus within an XR interface presented at a display of the XR headset; and
in accordance with a determination that the gaze data does not satisfy a gaze-quality threshold:
capturing image data at the XR headset indicating a projected-point position of a hand of the user within the XR interface;
determining, based on the image data and the projected-point position, a second point of focus within the XR interface presented by the display of the XR headset; and
presenting, at the XR headset, a gaze-to-hand switching indication, indicating that the image data and the projected-point position is being used to determine a point of focus, to the user.

18. The method of claim 17, further comprising:
while the XR headset is worn by the user:
in accordance with a determination that the image data does not satisfy an image-quality threshold:
capturing second gaze data at the XR headset;
determining, based on the second gaze data, a third point of focus within the XR interface presented by the display of the XR headset; and
presenting, at the head-wearable device, a hand-to-gaze switching indication, indicating that the second gaze data is being used to determine a point of focus, to the user.

19. A head-wearable device including one or more displays, one or more gaze-tracking devices, and one or more imaging devices, wherein the head-wearable device is configured to:
while the head-wearable device is worn by a user:
obtain gaze data captured at the one or more gaze-tracking devices;
determine, based on the gaze data, a first point of focus within an extended-reality (XR) interface presented at the one or more displays; and
in accordance with a determination that the gaze data does not satisfy a gaze-quality threshold:
obtain image data captured at the one or more imaging devices indicating a projected-point position of a hand of the user within the XR interface;
determine, based on the image data and the projected-point position, a second point of focus within the XR interface presented by the one or more displays; and
cause the one or more displays to present a gaze-to-hand switching indication, indicating that the image data and the projected-point position is being used to determine a point of focus, to the user.

20. The head-wearable device of claim 19, the head-wearable device further configured to:
while the head-wearable device is worn by the user:
in accordance with the determination that the gaze data does not satisfy the gaze-quality threshold and a determination that the user selects a second option of the one or more selectable options:
obtain other gaze data from the one or more gaze-tracking devices;
determine, based on the other gaze data, another point of focus within the XR interface presented by the one or more displays; and
cause the one or more displays to present a hand-to-gaze switching indication, indicating that the second gaze data is being used to determine a point of focus, to the user.
